(19) United States
(12) Patent Application Publication
(10) Pub. No.: US 2025/0064046 A1
(43) Pub. Date: Feb. 27, 2025

(54) MODULATING NOZZLE CONTROL SYSTEMS AND METHODS FOR SAME

(71) Applicant: Raven Industries, Inc., Sioux Falls, SD (US)

(72) Inventors: Jared Ernest Kocer, Sioux Falls, SD (US); John D. Preheim, Beresford, SD (US)

(21) Appl. No.: 18/813,786

(22) Filed: Aug. 23, 2024

Related U.S. Application Data
(60) Provisional application No. 63/578,943, filed on Aug. 25, 2023.

(51) Int. Cl. A01M 7/00; A01C 23/00; B05B 12/12

(52) U.S. Cl. CPC A01M 7/0089; A01C 23/007; B05B 12/126; A01M 7/0042

(57) ABSTRACT

A modulating nozzle controller for an agricultural sprayer includes one or more modulating nozzle assemblies each having a spray tip modulating element and an actuator operatively coupled with the spay tip modulating element. The spray tip modulating element controls an orifice profile of a spray tip. A processor system controls the orifice profiles of the one or more modulating nozzle assemblies and includes an agricultural product input to receive a specified field flow rate and a specified droplet size for an agricultural product and a sprayer speed input to receive an agricultural sprayer speed. A modulating nozzle profiler includes an orifice profile generator configured to generate an orifice profile instruction based on the specified field flow rate, the agricultural sprayer speed and the specified droplet size. The spray tip modulating element and the actuator control the orifice profile according to the orifice profile instruction to achieve the specified droplet size.

### PRIORITY APPLICATIONS

This application claims the benefit of priority to U.S. Provisional Patent Application Ser. No. 63/578,943, filed Aug. 25, 2023, the content of which is incorporated herein by reference in its entirety.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright Raven Industries Inc. of Sioux Falls, South Dakota, USA. All Rights Reserved.

### TECHNICAL FIELD

This document pertains generally, but not by way of limitation, to agricultural sprayers and control of agricultural sprayers.

### BACKGROUND

Agricultural sprayers apply agricultural products for husbandry in fields. For instance, sprayers apply agricultural products including fertilizers, herbicides, pesticides or the like. Agricultural sprayers include product reservoirs, sprayer booms and spray nozzles along the sprayer booms in communication with the product reservoirs.

Agricultural sprayers apply agricultural products from one or more product reservoirs through the spray nozzles. For instance, agricultural products are applied according to manufacturer specifications including field flow rate (e.g., gallons per acre or gpa) and droplet size, such as very coarse, coarse, medium, fine, ultrafine, and so on. In some examples, these field flow rate and droplet size specifications are provided with agricultural products to provide manufacturer advised efficacy in comparison to non-conforming droplet sizes, flow rates or the like. In other examples, the field flow rate and droplet size specifications may include different droplet sizes or field flow rates based on one or more of efficacy or environment (e.g., weather, humidity, wind speed, temperature change or the like). Spray tips (e.g., nozzle orifices) are installed to nozzle assemblies spaced along sprayer booms. The spray tips have orifice sizes (e.g., graduated with unitless numbers, millimeters or the like) that are configured to provide the specified droplet size at sprayed flow rates (gallons per minute or gpm). The sprayed flow rates are based on the specified field flow rate (gpa) and speed of the agricultural sprayer (ground speed).

With the spray tips installed the agricultural sprayer conducts the spraying operation with the specified product having the associated field flow rate and droplet size. The agricultural sprayer applies the agricultural product with sprayed flow rates (in gpm) that are based on the field flow rate (in gpa) and speed of the agricultural sprayer. For example, as the speed of the agricultural sprayer increases the agricultural sprayer increases the sprayed flow rate (based on the field flow rate) to account for the change in speed. The increase in sprayed flow rate is accomplished with increased pressure applied by one or more sprayer pumps to accordingly output the increased sprayed flow rate. Conversely, as the speed of the agricultural sprayer decreases the agricultural sprayer decreases the sprayed flow rate (e.g., by lowering pressure) to account for the lower speed.

The operator drives the agricultural sprayer at speeds that work with the specified field flow rate and specified droplet size associated with the agricultural product based on the installed spray tips. Care is exercised with operation to minimize deviations in speed that cause variation from the specified droplet size and field flow rate that may cause decreased efficacy, including decreased yield, product resistant pests (weeds, insects or the like), or the like.

### OVERVIEW

The present inventors have recognized, among other things, that a problem to be solved can include applying agricultural products according to specifications (field flow rate and droplet size) and at the same time permitting variations in agricultural sprayer speed (e.g., ground speed, nozzle movement or both) and application of various flow rates in each nozzle of the agricultural sprayer including nozzles at the periphery of sprayer booms. In other examples, agricultural sprayers include airborne systems, such as drones, having one or more nozzles that are moved through a field according to the agricultural sprayer speed, in this example an air speed. In one example the operator chooses spray tips having a static orifice for the agricultural sprayer. The static orifice is chosen (at least in part) based on specifications for an agricultural product. For instance, an example herbicide is selected for application and includes a manufacturer suggested prescription of 20 gallons per acre (e.g., specified field flow rate) and a coarse droplet size (e.g., specified droplet size). Spray tips having a static orifice size that permit application of the specified field flow rate and specified droplet size are selected by the operator. In operation, the agricultural sprayer applies the agricultural product at a sprayed flow rate from each of its nozzle assemblies. The sprayed flow rate is determined from the specified field flow rate and the speed of the agricultural sprayer. For instance, as the sprayer is driven at higher speeds, for a given specified field flow rate (e.g., 20 gallons per acre or gpa) the sprayed flow rate is increased to ensure application of 20 gallons of the agricultural product within each acre. Conversely, at slower speeds the sprayed flow rate is decreased to also ensure application of no more than 20 gallons of the agricultural product in each acre.

Further, with static spray tips combinations of sprayed flow rate and pressure are used to spray the agricultural product with the specified droplet size prescribed with the agricultural product. Changes to sprayed flow rate and pressure can cause deviations in droplet sizes outside of the specified droplet size for the agricultural product. In some examples, combinations of sprayed flow rate and pressure to produce a specified droplet size (e.g., coarse) are relatively narrow bands, ranges or the like and are difficult to achieve with variations in sprayer speed that affect sprayed flow rate and pressure.

Because the spray tips are static, as the sprayed flow rate is increased or decreased because of variations of sprayer speed the system pressure (e.g., pump pressure) is respectively increased or decreased to supply the agricultural product at the updated sprayed flow rate. The variations in sprayed flow rate are caused by changes in agricultural sprayer speed (ground speed) precipitated by turning, terrain grade, terrain variations (mud, water, soil characteristics, or the like), operator preference or the like. The associated changes in pressure change the pressure at the sprayer nozzles, and the increased or decreased pressure (and sprayed flow rate) may cause deviations in droplet size from the specified droplet size for the agricultural product. Accordingly, the operator (including an autonomous operator or controller) is limited to a range of agricultural sprayer ground speeds that permit maintenance of the droplet size while providing limited variation in sprayer flow rate and pressure. As an example, with the example herbicide agricultural product having a specified field flow rate of 20 gpa and a specified droplet size of coarse an increased sprayer speed of 15 miles per hour relative to an initial speed of 10 miles per hour increases the sprayed flow rate from 0.32 gallons per minute (gpm) at 10 mph to 0.38 gpm at 15 mph and the pressure is raised from 20 pounds per square inch (psi) to 30 psi. With the updated sprayed flow rate and pressure the droplet size produced with the static spray tip deviates from the specified coarse value to a medium droplet size and is accordingly outside of specification for the agricultural product. To achieve the specified coarse value the operator decreases the sprayer speed to correspondingly lower the sprayed flow rate and associated pressure.

In another example, the static spray tip is unable to deliver the agricultural product at the updated greater sprayed flow rate because the static spray tip is not large enough (e.g., does not have an adequate nozzle orifice) to accommodate the increased flow rate. This is referred to as ‘deadheading’ and is further discussed below. These deviations may, in some examples, decrease efficacy of the agricultural product. For instance, the herbicidal benefits of the agricultural product are not fully achieved with smaller or larger droplet sizes or less than specified sprayed flow rates. Accordingly, to maintain application of the agricultural product within specifications the agricultural sprayer is driven within a limited range of speeds. In some cases, such as with turning, grades, variations in soil conditions or the like, operator preferences to complete the operation more quickly, or the like it can be difficult to maintain the agricultural sprayer within this range of speeds. In still other examples, spraying operations have longer durations because the agricultural product cannot be applied at greater speeds without deviating from a specified droplet size thereby increasing labor and limiting the conduct of additional spraying operations.

In another example, nozzle assemblies positioned along sprayer booms move at different speeds, for instance while navigating fields, making turns or the like. For instance, nozzle assemblies at the periphery of a sprayer boom on the inside of a turn move relatively slowly in comparison to the sprayer chassis speed, and in some examples may move backward relative to the chassis. In contrast, the nozzle assemblies proximate to the sprayer chassis move at speeds approximating those of the sprayer. Further, the nozzle assemblies on the periphery of a sprayer boom on the outside of a turn move more quickly in comparison to the sprayer chassis because they move with the ground speed of the chassis and with rotation of the sprayer boom.

The variation in speeds of the nozzle assemblies cause a number of issues. In an example, because the speeds are different a sprayed flow rate based on the agricultural sprayer (chassis) speed is not accurate for the interior (to the turn) nozzles or exterior nozzles. For the interior nozzles the sprayed flow rate is too great and results in over application. For the exterior nozzles the sprayed flow rate is too little and results in under application. In some examples, valve control, for instance with solenoid-based pulse width modulation, permits a degree of variation in flow rates for nozzle assemblies including static spray tips. However, along the periphery, for instance the exterior nozzles of a turn, even with pulse width modulation it may be difficult to achieve both a specified sprayed flow rate for the greater speed as well as the specified droplet size for the agricultural product. Instead, the exterior nozzle nozzles experience ‘deadheading’. The exterior nozzles apply the agricultural product at a sprayed flow rate that falls below the specified sprayed flow rate because the spray tip is not large enough to accommodate the increased flow rate.

In some examples, pests such as weeds, insects or the like, receive a low enough quantity of the agricultural product (e.g., herbicide or insecticide) that mortality is avoided. The pest then develops resistance to the agricultural product and passes the resistance on to future generations. In some examples, the agricultural product becomes ineffective against future generations of the resistant pest even when later applied at specified flow rates and droplet sizes.

The present subject matter provides solutions to these problems with a modulating nozzle control system. The modulating nozzle control system includes a modulating nozzle controller, such as a processor system that receives prescriptions for input agricultural products including one or more of field flow rate and droplet size. The modulating nozzle control system includes one or more modulating nozzle assemblies. The modulating nozzle assemblies each include a spray tip modulating element at a spray tip having an orifice profile. An actuator is operatively coupled with the spay tip modulating element, and the spray tip modulating element is configured to control the orifice profile (e.g., maintain the profile, change the profile, or the like).

The modulating nozzle controller, in one example a processor system including one or more processors, is configured to control the orifice profiles of the one or more modulating nozzle assemblies. The processor system includes an agricultural product input configured to receive a specified field flow rate and a specified droplet size for an agricultural product. The specified field flow rate and droplet size may include a range of flow rates or droplet sizes that vary according to weather, wind, humidity, application or the like. The processor system further includes a sprayer speed input configured to receive an agricultural sprayer speed, such as a ground speed, speed of one or more of the modulating nozzle assemblies (e.g., ground speed modified with rotational speed). A modulating nozzle profiler of the processor system is in communication with the agricultural product input, the sprayer speed input and the one or more modulating nozzle assemblies. The modulating nozzle profiler includes an orifice profile generator configured to generate an orifice profile instruction based on the specified field flow rate, the agricultural sprayer speed and the specified droplet size. The spray tip modulating element and the actuator are configured to control the orifice profile according to the orifice profile instruction to maintain the specified droplet size.

The modulating nozzle control system provides orifice profile instructions to the modulating nozzle assemblies that maintain a specified droplet size. For instance, as a sprayed flow rate for one or more of the nozzle assemblies changes with variations in sprayer ground speed, turning of the sprayer booms or the like, the orifice profile instructions are varied and the spray tip modulating element is controlled (e.g., enlarged, contracted, maintained) to maintain the specified droplet size in cooperation with the change in sprayed flow rate. The cooperative variation of sprayed flow rate and modulating nozzle assembly control permits the maintenance of the specified droplet size in contrast to static nozzles that instead experience increased or decreased pressure to achieve varied sprayed flow rates while failing to maintain specified droplet size.

Further, the modulating nozzle control system overcomes ‘deadheading’ issues experienced with some example static nozzles. Because the orifice profile is varied with the modulating nozzle control system a sprayed flow rate that would deadhead, or fail to achieve that flow rate through a static nozzle, is achieved with the modulating nozzle control system. Further, increased pressure that is, in some examples, used to achieve greater sprayed flow rates is unnecessary (e.g., eliminated or decreased) with the modulating nozzle control system. Instead, the control system enlarges the modulating nozzle assembly orifice profile (according to the controller generated orifice profile instruction) to facilitate greater sprayed flow rate without pressure increase (including an attenuated pressure increase). The combination of increased (or decreased) sprayed flow rate, decreased pressure variation, and orifice profile control permits the maintenance of a specified droplet size (e.g., coarse) without pressure variations that otherwise cause deviation of droplet size relative to specification. Further, the modulating nozzle control system and the modulating nozzle assemblies permit relatively low and high sprayed flow rates, for instance at the peripheral portions of a spray boom that experience greater rotational speed (e.g., while turning), while maintaining specified droplet size.

This overview is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a perspective view of one example of an agricultural sprayer.

FIG. 2 is a schematic view of the agricultural sprayer of FIG. 1 conducting a spraying operation in a field.

FIG. 3 is a schematic view of the agricultural sprayer of FIG. 1 conducting a turn as part of a spraying operation.

FIG. 4 is a chart showing spray flow rates, system pressures, and spray tip sizes.

FIG. 5A is a perspective view of one example of a modulating nozzle assembly.

FIG. 5B is an exploded view of the modulating nozzle assembly of FIG. 6A.

FIG. 6 is a schematic of one example of a modulating nozzle controller.

FIG. 7 is a chart showing spray flow rates and system pressures for the modulating nozzle assembly of FIGS. 5A, 5B.

FIG. 8 is a chart showing correspondence of specified spray flow rates on a per nozzle basis relative to actual spray flow rates for nozzle assemblies spaced along sprayer booms.

FIG. 9 is a block diagram showing one example of a machine configured to perform one or more of the methods described herein and control a modulating nozzle assembly.

### DETAILED DESCRIPTION

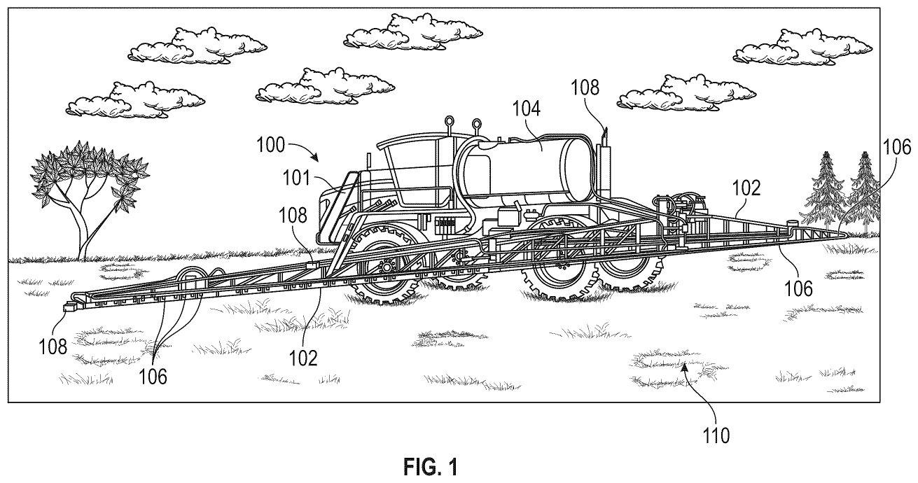

FIG. 1 is a perspective view of one example of an agricultural vehicle, an agricultural sprayer 100 in a field 110. As provided herein, the agricultural sprayer 100 is representative of an agricultural vehicle having an agricultural implement (e.g., a combine) or coupled with an agricultural implement (e.g., a tractor coupled with a cultivator, planter or the like). The sprayer 100 includes a chassis 101 having ground engaging elements 103, a power source for the ground engaging elements, steering system, and one or more control systems including, but not limited to, an operator cab, autonomous control system or the like.

In the example shown in FIG. 1, the sprayer 100 includes sprayer booms 102 extending laterally from the chassis 101. A plurality of modulating nozzle assemblies 106 are distributed along each of the sprayer booms 102, for instance at a specified spacing corresponding to the spacing between crop rows. As described herein, the modulating nozzle assemblies 106 include one or more spray tip modulating elements that permit the control of one or more characteristics of an agricultural product from spray tips. For instance, the spray tip modulating elements are coupled with associated actuators and the spray tip modulating elements control modulating port profiles at the spray tips and the corresponding spray profile of the agricultural product sprayed from the spray tip. Additionally, the spray tip modulating elements permit variation in the flow rate of the agricultural product from the spray tip (e.g., larger orifice profiles permit greater flow, and conversely smaller orifice profiles constrain flow). The modulating nozzle control system examples described herein control orifice profiles based on one or more inputs including an agricultural product input, such as specified field flow rate, specified droplet size or the like; sprayer speed input, the speed of the sprayer chassis 101, one or more modulating nozzle assemblies or the like. Accordingly, discrete and customized sprayed flow rates, spray profiles (e.g., droplet size, pattern profile) or the like for modulating nozzle assemblies are achieved with the modulating nozzle control system. An agricultural sprayer including the modulating nozzle control system thereby varies performance of the modulating nozzle assemblies along a sprayer boom, between booms or the like to address variations in speed (e.g., one or more of chassis speed, rotational speed of nozzle assemblies), optional variations in other characteristics, such as wind speed, prescription values or the like, and provide specified spray profiles (e.g., droplet size, spray pattern or the like) and sprayed flow rates that account for these characteristics while also achieving a specified field flow rate.

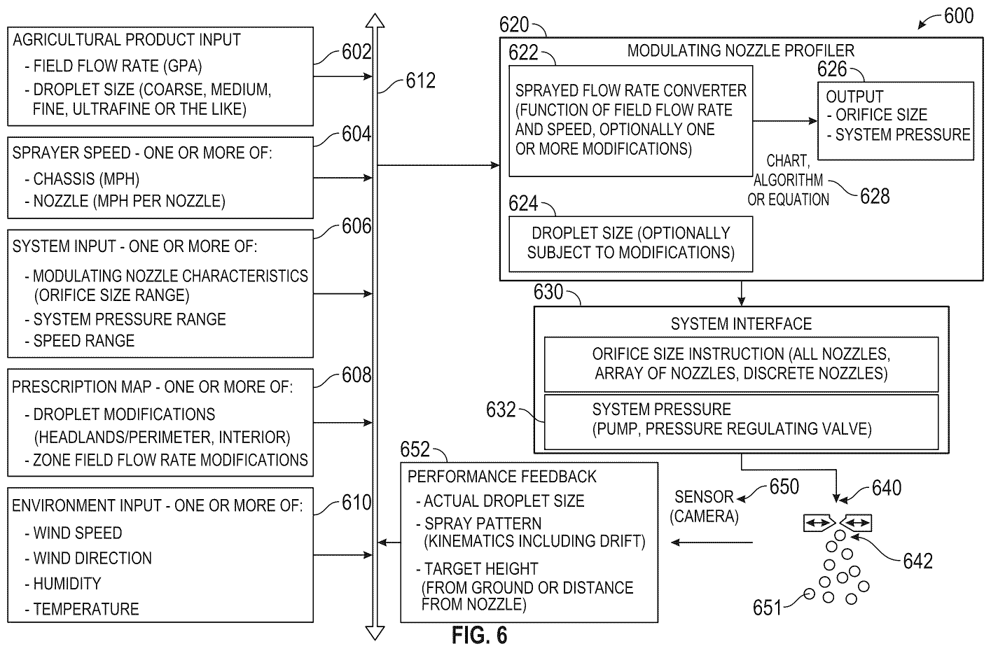

The modulating nozzle control system is in communication with one or more sensors coupled with the sprayer 100 including, but not limited to, kinematic sensors for position, speed or acceleration measurements of the sprayer 100; or position fiducial sensors 108 (e.g., GPS sensors, RTK fiducial markers or the like) provided along one or more of the sprayer booms 102 or the sprayer chassis 101. In another example, and as shown in FIG. 6, one or more nozzle associated sensors 650 are included to monitor characteristics of the actual spray profile generated by one or more modulating nozzle assemblies, such as, droplet size, spray kinematics (droplet speed, direction or the like), spray pattern or the like. The nozzle associated sensors 650 include, but are not limited to, cameras, video cameras, ultrasound sensors or the like.

In operation the agricultural sprayer 100 is navigated through the field 110, for instance with the ground engaging elements 103 (wheels, tracks or the like) position between crop rows, while the modulating nozzle assemblies 106 are operated to spray one or more agricultural products on the crops. As described herein, one or more spray characteristics, for each of the modulating nozzle assemblies 106 are controlled during operation (e.g., by control of a spray tip orifice profile) to provide a specified sprayed flow rate of the agricultural product with a specified spray profile (e.g., droplet size).

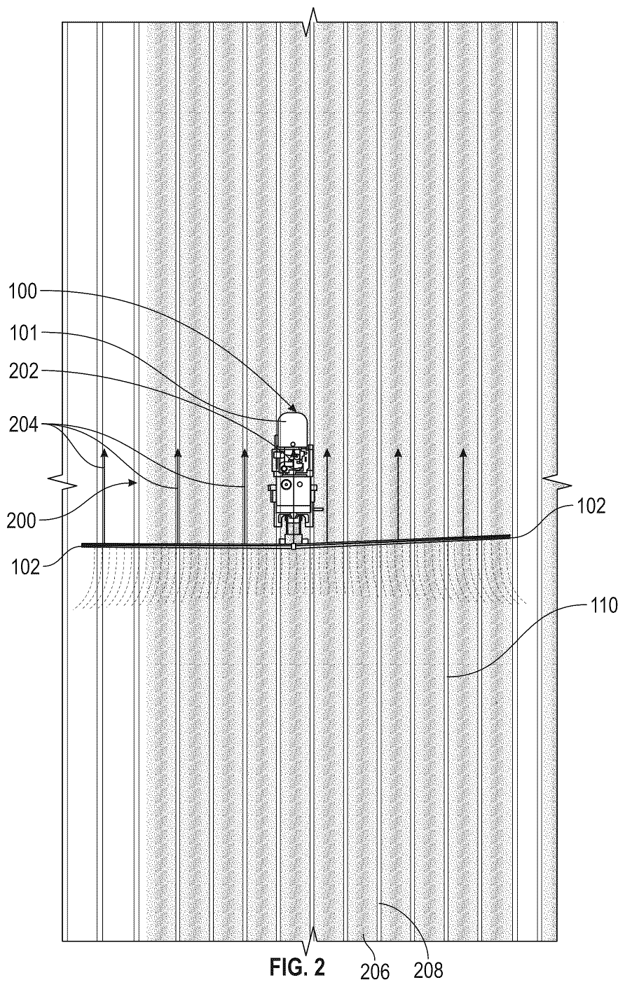

FIG. 2 is a schematic view of the agricultural sprayer 100 in the field 110. The agricultural sprayer 100 is driving along crop rows 206, for instance with its ground engaging elements (103 in FIG. 1) in the furrows 208 between the crop rows 206. As shown, the agricultural sprayer 100 is driving along generally straight crop rows 206, and the chassis speed 202 is illustrated with an arrow overlying the chassis 101. The sprayer booms 102 are shown in a deployed configuration while applying the agricultural product to the crops in the crop rows 206. The nozzle assembly speed 204 of one or more modulating nozzle assemblies is shown with similar arrows having a common size (magnitude) and direction to the chassis speed 202 arrow. When referring to the speeds 202, 204 the terms are indicative of one or both of vectors (e.g., velocity) and magnitude (speed). Because the agricultural sprayer 100 is moving along generally straight crop rows 206 in the example shown in FIG. 2 the chassis speed 202 and nozzle assembly speeds 204 are similar (e.g., same, within one mile per hour of each other, or the like). The speeds 202, 204 are determined in examples with the sensors, position fiducial sensors 108, kinematic sensors or the like installed to the agricultural sprayer 100. For example, the position fiducial sensors 108 (GPS, RTK, or the like) determine the speeds 202, 204 or kinematic sensors (e.g., a speedometer, accelerometer, position sensor or the like) are provided with the sprayer 100 to determine the chassis speed 202 in combination with one or more yaw sensors (e.g., gyroscope or position fiducials that permit rotation measurement) to mathematically determine nozzle assembly speeds 204.

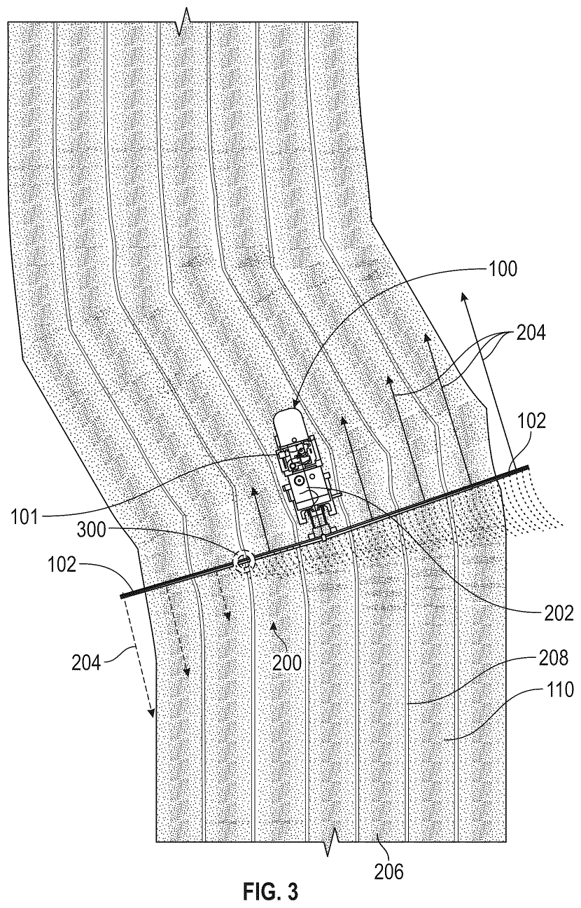

FIG. 3 is a schematic view of the agricultural sprayer 100 in the field 110. The agricultural sprayer 100 is driving along crop rows 206 and, as shown, is turning to follow a curve in the crop rows 206. The chassis speed 202 is illustrated with an arrow overlying the chassis 101 as similarly shown in FIG. 1. The agricultural sprayer 100 turns at a virtual pivot 300 as shown in FIG. 1 to navigate the turn. For example, the location of the virtual pivot 300 illustrated with a circle along the left sprayer boom 102 has a ground speed of 0 mph. The nozzle assembly speeds 204 of one or more modulating nozzle assemblies are shown with varied arrows having different sizes. The nozzle assembly speeds 204 vary because of rotational movement, and corresponding rotational speed, as well as the varied positions of the modulating nozzle assemblies 106 (see FIG. 1) along the sprayer booms 102. The negative speed shown with the reversed arrows in FIG. 1 along the distal portion of the left sprayer boom 102 is indicative of that portion of the sprayer boom 102 moving backward over portions of the field that are previously sprayed, and accordingly double application is avoided (e.g., the sprayed flow rate on along this portion is 0 gallons per minute). The modulating nozzle assemblies 106 (see FIG. 1) proximate the distal ends of the right sprayer boom 102 in FIG. 3 move at a greater rotational speed and associated ground speed because of the greater distance from the chassis 101 of the agricultural sprayer 100. The kinematics of the modulating nozzle assemblies 106 (e.g., speed 204, velocity, acceleration, position or the like) are determined in examples with the sensors, position fiducial sensors 108, kinematic sensors or the like installed to the agricultural sprayer 100. Optionally, one or more yaw sensors (e.g., gyroscope or position fiducials that permit rotation measurement) facilitate the determination of nozzle assembly speeds 204.

As discussed herein, one or more of the chassis speed 202 or nozzle assembly speeds 204 are determined (e.g., measured, derived from measured values or the like) and input to a processor system of a modulating nozzle control system 600 (see FIG. 6) to determine orifice profile instructions for the modulating nozzle assemblies 106 (an example nozzle assembly 604 is shown in FIG. 6). Variations in speeds 202, 204 cause variations in sprayed flow rates for each of the modulating nozzle assemblies 106 as discussed herein. For instance, modulating nozzle assemblies 106 having backward (stippled arrows in FIG. 3) have a sprayed flow rate such as zero gallons per minute while nozzle assemblies 106 having progressively greater speeds 204 have corresponding greater sprayed flow rates. The orifice profile instructions correspond to one or more of specified shapes, sizes or the like for control of the associated modulating nozzle assemblies 106 to spray an agricultural product with one or more spray profile characteristics including, but not limited to, droplet size or spray pattern. The modulating nozzle control system 600 thereby permits the discrete control of each of the modulating nozzle assemblies 106 (including subsets of two or more nozzle assemblies) to provide varied sprayed flow rates from the nozzle assemblies 106, based on variations of nozzle assembly speeds 204, all while achieving specified droplet sizes at each of the modulating nozzle assemblies 106.

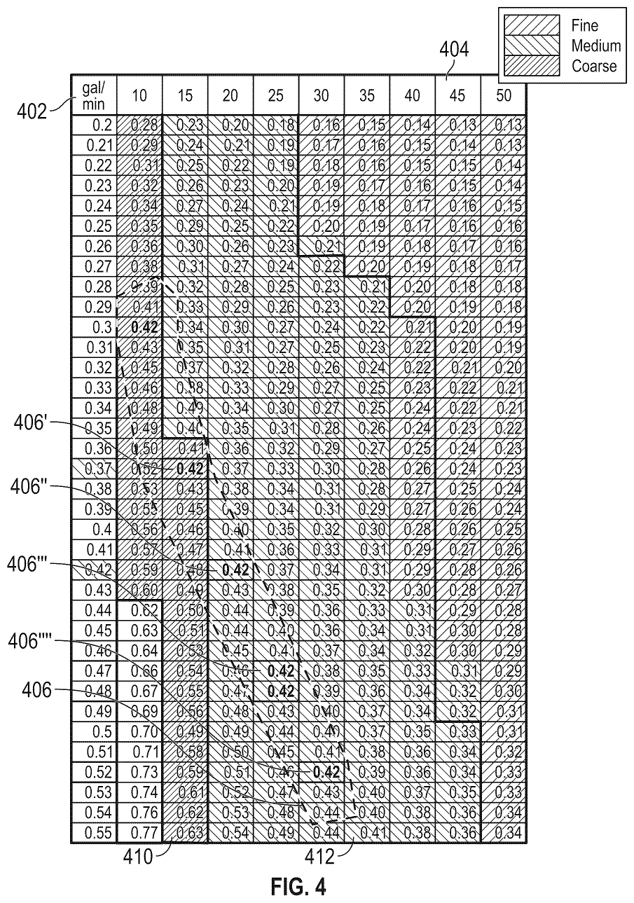

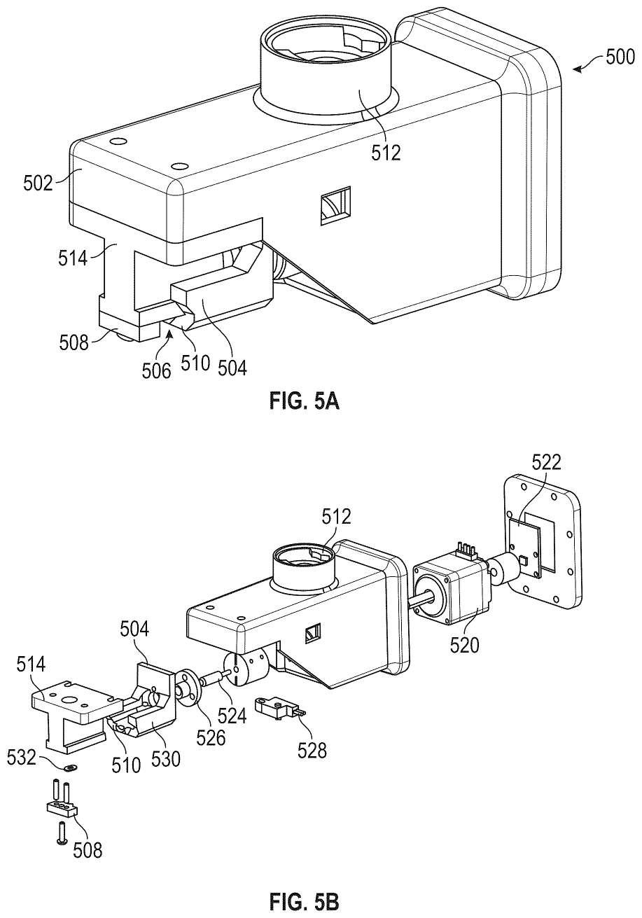

FIG. 4 is a flow rate and pressure plot 400 illustrating spray profile performance characteristics for various static nozzles having static nozzle orifices, such as a static 0.42 millimeter orifice profile, in contrast to the modulating nozzle assemblies 106 (500 in FIGS. 5A, B, and 604 in FIG. 6) having modulating orifice profiles. As discussed herein below, static nozzles spray agricultural product with variations in one or more spray profile performance characteristics, such as droplet size according to variations in sprayed flow rate at the static nozzles. The variation in spray profile characteristics in some examples, undesirably, sprays agricultural products outside of specifications, for instance with droplet sizes that are above or below specification.

Referring again to FIG. 4 nozzle flow 402 rates are provided in the left column of the plot 400. As shown the nozzle flow rates escalate from the upper portion of the plot 400 to its lower portion. The nozzle flow rates 402 are, in one example, based on a specified field flow rate (e.g., in gallons per acre) and the speed of the sprayer. As the sprayer 100 is driven faster or slower the nozzle flow rate, for a given specified field flow rate, goes up or down in a related manner. Accordingly, higher nozzle flow rates 400 are associated with higher sprayer speed (e.g., of the sprayer itself, speeds of the nozzle, for instance during a turn at a position spaced from the vehicle or virtual pivot 300 along a sprayer boom 102).

Pressure values 404 are along the top row of the plot 400. The pressure values 404 escalated from the left to the right, and permit the application of an agricultural product at varying nozzle flow rates with static nozzles. For example, as flow rate increases or decreases pressure is raised or lowered (e.g., to push the corresponding lower or higher volume of agricultural product). With a static nozzle pressure is raised as flow rate is raised to push the (increased) nozzle flow rate of fluid through the static nozzle. However, increased pressure for the increased nozzle flow rate conversely decreases droplet size with a static nozzle. In some examples, the variation in droplet size causes the droplet size to deviate from the specified value (e.g., coarse to fine). Conversely, decreased pressure for a decreased nozzle flow rate increases droplet size with a static nozzle. Droplet size bands are shown with differing stippling in FIG. 4, and include a coarse droplet band 410, medium droplet band 412, and fine droplet 414. In other examples, additional bands are included, such as ultrafine and super coarse. In still other examples, a sprayer system may not have pump capability or to raise pressure to the value specified for the specified nozzle flow rate. In such an example, the nozzle may simply fail to spray the specified nozzle flow rate and instead ‘deadheads’ at a flow rate lower than the specified nozzle flow rate.

One example of a static orifice performance zone 406 is illustrate with the circled dashed zone in FIG. 4. In an illustrative example, initially at a first performance zone position 406′ the sprayer 100 speed is 12 miles per hour and the resulting nozzle flow rate is 0.37 gallons per minute based on a specified field flow rate (e.g., in gallons per acre or similar). At this nozzle flow rate, a static nozzle size of 0.42 (mm) and a pressure of 15 pounds per square inch (psi) cause spraying of coarse droplets from the static nozzle as specified for the example agricultural product. In a second performance zone position 406″ As the operator drives the sprayer 100 at a greater speed (e.g., 15 mph), the nozzle flow rate is correspondingly increased to 0.42 gpm based on the specified field flow rate and the pressure is raised to 20 psi to achieve the higher nozzle flow rate. However, with the static nozzle of 0.42 mm, as shown in FIG. 4 the droplets sprayed from the static nozzle deviate from the coarse band 410 droplet size specification to the medium range 412. The agricultural product is thereby sprayed outside of specification, at a smaller droplet size in this example, and the sprayed agricultural product may have one or more of decreased efficacy, for instance because of wind drift effect on the smaller droplets.

Additional third and fourth performance zone positions 406″′ and 406″″ of the static orifice zone 406 are shown in FIG. 4. In each of these positions the nozzle flow rate 402 and pressure 404 are raised relative to the second position 406″. As shown the droplet size of the sprayed agricultural product remains in the medium droplet band 412. As nozzle flow rates 402 and pressures 404 escalate, for instance with higher sprayer 100 speeds, the static orifice performance zone 406 is extrapolated and transitions from the medium droplet band 412 to the fine droplet band 414.

FIG. 4 illustrated performance of a static nozzle. FIGS. 5A, 5B, conversely, show an example modulating nozzle assembly 500 that includes a spray tip modulating element 504 to permit control (e.g., maintenance, change or the like) of the orifice profile of a spray tip 506. Referring first to FIG. 5A, the modulating nozzle assembly 500 is shown in an assembled configuration. The assembly 500 includes a nozzle base 502. The nozzle base 502 in one example is coupled with one or more of the sprayer boom 102 (FIG. 1) and a boom tube provided with the sprayer boom 102. One or more of agricultural products including, but not limited to, premixed agricultural products, carrier fluid, injection product(s) or the like are received at the modulating nozzle assembly 500 through one or more input fittings 512. FIGS. 5A, 5B show the input fitting 512. In other examples, multiple input fittings 512 are included to respectively receive and permit the mixing of multiple products, such as a carrier fluid and injection products that are mixed at the modulating nozzle assembly 500 to from agricultural products having specified compositions, concentrations or the like in an immediate fashion (including near immediate such as within 0.5 seconds or less) at the assembly 500.

The modulating nozzle assembly 500 includes a nozzle base 502. A spray tip modulating element 504, such as a shuttle (e.g., block, plate, shuttle or the like) is movably coupled with the nozzle base 502. Each of the spray modulating element 504 and the nozzle base 502 include respective shuttle and base edges 510, 508. The base edge 508 and the shuttle edge 510 form at least a portion of the perimeter of one or more orifices of the spray tip 506. Accordingly, movement of one or both of the base edge 508 or the shuttle edge 510 relative to the other edge controls the orifice profile (e.g., size or shape of the orifices of the spray tip 506).

The modulating nozzle assembly 500 further includes a guide rail 514 movably coupled with a rail follower 530 of the spray tip modulating element 504. In the example shown in FIG. 5B, the guide rail 514 is separable component of the remainder of the nozzle base 502, for instance to permit replacement of one or more of the rail 514, the associated base edge 508 or the like. In another example, the guide rail 514 is an integral component to the nozzle base 502 (in a similar manner to the modulating nozzle assembly 500). The rail follower 530 of the spray tip modulating element 504 includes one or more of a complementary recess, groove or the like coupled with the guide rail 514. The rail follower 530 and guide rail 514 in combination guide movement of the spray tip modulating element 504, for instance between various open, closed and intermediate orifice profiles of one or more spray ports of the spray tip 506.

In the example assembly 500 shown in FIG. 5B, the base edge 508 is a replaceable component of the nozzle base 830. For instance, the base edge 508 is a fitting, insert or the like configured for coupling with the remainder of the nozzle base 830, such as guide rail 514. The base edge 508 is replaceable (along with the spray tip modulating element 504) to address wear, failure or the like without requiring replacement of the entire modulating nozzle assembly 500. In another example, the base edge is integral to the guide rail 514 and both are replaced at the same time.

Referring again to FIG. 5B, transmission feature 524 is coupled with the actuator 520. The transmission feature 524 is, in this example, a shaft that transmits rotation from the actuator 520 to the spray tip modulating element 504 to translate the element 504. The spray tip modulating element 504 includes a complementary fitting 526 (e.g., threading) such as a nut, lug, rotational bearing or the like, having threading. The threading of either or both of the element 504 or the transmission feature 524 are interfit. Accordingly, rotation of the actuator 520 and transmission feature 524 causes translation of the spray tip modulating element 504.

Additionally, the example modulating nozzle assembly 500 includes a nozzle controller 522, such as an electronic control unit (ECU), processor, processor on a board or the like interconnected with the actuator 520 to permit automated control of the orifice profile of the spray tip 506. The nozzle controller 522 is interconnected with the actuator 520 to permit automated control of the orifice profile of the spray tip 506. A position sensor 528 is optionally provided with the assembly 500. In the example shown in FIG. 5B the position sensor 528 is interposed between the nozzle controller 522 and the actuator 520. The position sensor 528 includes, but is not limited to, a magnetic encoder, optical encoder or the like that counts or measures rotation of the actuator 520 or measures the position of the spray tip modulating element 504 and thereby determines the position of the element 504 and the corresponding orifice profile of the spray tip 506.

FIG. 6 is a schematic diagram of an example modulating nozzle control system 600 configured to control one or more modulating nozzle assemblies 640. The system 600 is provided in various examples as one or more processors and associated components, such as memory, input, sensors or the like. The modulating nozzle assembly 604 in FIG. 6 is representative of one or a plurality of modulating nozzle assemblies 640 that receive orifice profile instructions from the system 600 to control (e.g., maintain, change, or the like) the orifice profiles 642 of the of the assemblies. As described herein, the orifice profile instructions optionally vary between modulating nozzle assemblies 640 according to differences in speeds of the nozzle assemblies, specified droplet sizes or the like. The orifice profile instructions are received by the modulating nozzle assemblies 640 and the assemblies 640 modulate their respective orifice profiles to provide associated spray profiles of the agricultural product, for instance having a specified spray profile, such as sprayed flow rate, specified droplet size or the like.

Referring again to FIG. 6, the example modulating nozzle control system 600 includes one or more inputs 602-610 interconnected with the remainder of the system 600 by an interface 612, such as wired connections (e.g., ethernet), wireless connections (e.g., wifi), bus, CAN bus or the like. One example of an input, an agricultural product input 602, provides one or more field flow rate (gallons per acre, or gpa), specified droplet size (microns, coarse, medium, fine, ultrafine, combinations or similar) or the like to the system 600. For instance, an operator scans an agricultural product label, bar code or the like, looks up internet or literature information on the agricultural product having the information for input. In some examples, a plurality of field flow rates or droplet sizes are provided that are associated with (e.g., indexed to) various environmental conditions to achieve a specified efficacy. For instance, an operator may scan an agricultural product label, bar code or the like and obtain an initial field flow rate and specified droplet size. The information provided with the agricultural product may, in some examples, detail droplet sizes, field flow rates or the like associated with different environmental conditions including, but not limited to, wind speed, humidity, temperature or the like, including ranges of the conditions. Optionally, the operator inputs these variations (including ranges of values) in field flow rate, specified droplet size or the like.

The prescription map input 608, shown in FIG. 6, includes different zones of a map having associated field flow rates, specified droplet sizes or the like. In some examples, the associated values are modifications (e.g., percentages, variations in quantities or the like) that address features of the associated zones, such as elevated terrain subject to relatively greater windspeeds, sunlight or the like having associated requisites for larger droplet sizes, enhanced flow rates or the like relative to the initial agricultural product input 602 values. In other examples, depressed or wind sheltered terrain zones of the prescription map include associated requisites for smaller droplet sizes, decreased flow rates or the like relative to the initial product input values 602. In still other examples, a prescription map received with the prescription map input 608 includes values representative of an overall prescription for spraying such as, but not limited to, agricultural product concentrations and constitutions, field flow rates, spray profile characteristics (e.g., droplet size, spray pattern, or the like), boom heights, spray targets (e.g., crop, weed, pest, soil, or the like). In various examples the values are indexed to zones, and optionally are varied between zones to account for variations in treatment specifications; elevation; grade; observed pests, weeds, or crop health; or the like. These values are in some examples based on the agricultural product specifications received with the agricultural product input 602. For example, the input agricultural product is fused with the prescription map to populate the map with specified field flow rates, specified spray profile characteristics (e.g., droplet sizes), or the like that include variations based on characteristics associated with the zones (e.g., elevation, grade, flow rate variations, droplet size variations or the like).

Optionally, the system 600 includes an environment input 610 that provides information regarding conditions in the field, such as windspeed, wind direction, humidity, temperature, precipitation or the like. The environment input 610 in some examples receives information from the operator (entering field conditions, such as weather). In other examples, the environment input 610 communicates with a weather service, website or the like that provides condition information, such as weather (e.g., windspeed, direction, humidity, temperature, precipitation or the like). As described herein, in various examples the modulating nozzle profiler 620 adjusts orifice profile generation to account for the input field conditions.

Additional inputs 604, 606 are shown in FIG. 6. The sprayer speed input 604 provides one or more of the chassis speed (202 in FIGS. 2 and 3) or nozzle assembly speeds (204 in FIGS. 2 and 3), collectively agricultural sprayer speed 200, of one or more of the modulating nozzle assemblies 106 to the system 600. For example, the sprayer speed input 604 is in communication with one or more of a speedometer, GPS sensors or RTK sensors (also referred to as fiducials), gyroscope, inertial measurement unit (IMU) or the like that facilitates determination of kinematics of the sprayer 100 including, but not limited to, position, speed, acceleration, rotational speed, rotational acceleration, translational counterparts to the rotational kinematics or the like. In some examples, the chassis speeds and nozzle speeds are provided or converted to units of miles per hour (mph) or similar to facilitate determination of sprayed flow rates for the associated modulating nozzle assemblies 106 (in FIGS. 1, and 604 in FIG. 6).

A system input 606 is shown in FIG. 6 and provides one or more characteristics of the sprayer 100, such as, but not limited to, modulating nozzle assembly characteristics (e.g., one or more of orifice size range, orifice shape range or the like); system pressure values including specified values, ranges of values or the like; speed range such as an operator specified range of speeds for operation of the sprayer 100. In various examples, the specified characteristics supplied with the system input 606 provide associated values to the modulating nozzle profiler 620, and the profiler 620 in turn generates orifice profiles, specifies system pressure or the like while working with the input characteristics from the system input 606. For example, with a specified range of modulating nozzle assembly characteristics, specified range of system pressures, and specified speed range the modulating nozzle profiler 620 accordingly generates orifice profile instructions (and optionally system pressures) that remain within the associated specified ranges (e.g., of one or more of the orifice or speed) while also spraying the agricultural product at a specified sprayed flow rates corresponding to the modulating nozzle speeds with a specified droplet size.

Referring again to FIG. 6, the modulating nozzle profiler 620 is show in communication with the interface 612 and in turn with one or more of the inputs 602-610. The modulating nozzle profiler 620 generates orifice profile instructions for one or more of the modulating nozzle assemblies 640 that permit actuation at the assemblies 640 to achieve specified orifice profiles 642 that provide the agricultural product at specified sprayed flow rates for the assemblies 640 with sprayed droplets of specified sizes for the assemblies 640.

The modulating nozzle profiler 620 includes sprayed flow rate converter 622 and a droplet size output 624. The sprayed flow rate converter 622 receives the field flow rate from the agricultural product input 602 and optionally one or more inputs 602-610, such as sprayer speed 604. The converter 622 generates a sprayed flow rate for one or more of the modulating nozzle assemblies 640 as a function of the field flow rate and speed of the assemblies 640 under consideration. As discussed herein, the nozzle assembly speeds 204 of the modulating nozzle assemblies 604 vary according to position along the sprayer booms 102, turning of the sprayer 100 (see FIG. 1) or the like. Greater chassis and nozzle assembly speeds 202, 204 increase the sprayed flow rates for the assemblies 604, while lesser chassis speeds 202 and counter rotation (e.g., backward) of assemblies 604 during a turn decrease sprayed flow rates for those assemblies 604 (including arresting of flow, 0 gallons per minute). In an example, the increased or decreased sprayed flow rates are different for each of the modulating nozzle assemblies 604 as more distally positioned nozzle assemblies have greater rotational (and associated) translational speed than nozzle assemblies proximate to the chassis 101 or virtual pivot 300, see FIG. 3. In another example, inputs, such as the prescription map input 608, include variations in field flow rate for zones in a field, and the sprayed flow rate converter 622 refines the corresponding sprayed flow rates to account for the zone variations.

The droplet size output 624 receives the specified spray profile (e.g., specified droplet size, spray pattern or the like) from the agricultural product input 602 and outputs a specified droplet size for the modulating nozzle assemblies 604. In some examples the specified spray profile, such as specified droplet size, is modified according to one or more of the inputs 602-610. For instance, one or both of the prescription map input 608, environment input 610 or the like include characteristics that refine the determination of the droplet size output 624. For instance, elevated terrain or greater wind speeds prompt increasing the droplet size (e.g., from medium to coarse) while depressed terrain subject to lesser wind speeds, zones marked for enhanced efficacy (e.g., greater droplet adhesion to crops), or the like prompt decreasing the droplet size (e.g., from medium to fine). The droplet size output 624 determines the specified droplet size for the associated modulating nozzle assemblies, and may vary the specified droplet sizes between different modulating assemblies 640 (106 in FIG. 1) according to position along the sprayer boom 102, prescription zones containing associated assemblies 640 or the like. In another example, the droplet size output 624 varies specified droplet size with modulating nozzle assemblies 604 proximate distal ends of the sprayer booms 102 having larger droplet sizes to decrease spray drift while assemblies 604 interior to the distal ends have smaller (e.g., such as the initial droplet size from the agricultural product input 602) specified droplet sizes to enhance efficacy of the agricultural product.

In other examples, the inputs received from the input features 602-610 are fused together by the modulating nozzle profiler 620 (e.g., as a standalone processor, a component of a field computer or the like). For instance, the inputs are synthesized together to permit the determination of specified sprayed flow rates specified spray profile (e.g., droplet size, spray pattern, boom height or the like) with the sprayed flow rate converter 622 and the droplet size output 624 (in some examples a spray profile output). The fused inputs, such as a prescription map (e.g., field flow rate and pressure per zone, or the like), weather input, product label specifications, coverage sensor measurements, spray profile observations or the like are received by the modulating nozzle profiler 620 and synthesized to develop sprayed flow rates and spray profile specifications for output and implementation by the modulating nozzle assemblies 640.

The sprayed flow rates from the sprayed flow rate converter 622 and the specified droplet sizes output from the droplet size output 624 are provided to an orifice profile generator 628. The orifice profile generator 628 includes one or more of charts, algorithms or equations that determine orifice profiles (and optionally system pressure) based on each of the specified droplet size and specified sprayed flow rate for a respective modulating nozzle assembly 640. In examples, the orifice profile generator 628 receives one or more inputs from the system input 606, such as system pressure range and modulating nozzle characteristics (e.g., orifice size range) that condition the generator 628, such as charts, algorithms, or equations to work within the specified ranges or characteristics and generate orifice profile values and system pressure values within the specified ranges or characteristics.

In a sprayer 100 having a plurality of modulating nozzle assemblies 640 each with a respective specified droplet size and a specified sprayed flow rate the orifice profile generator determines one or both of an orifice profile or system pressure for the associated spray port of the modulating nozzle assembly 640 (500 in FIGS. 5A, B). When one or both of the orifice profile or system pressure are implemented at the assembly 640, the agricultural product is sprayed with the specified droplet size at the specified sprayed flow rate for the nozzle assembly 640. In one example, the orifice profile includes an orifice size for the modulating nozzle assembly 640. In other examples, the orifice profile includes one or more of the orifice size, shape, system pressure specified for the system or the discrete modulating nozzle assembly 640, or the like.

The specified orifice profile 626 (and optionally system pressure) determined with the orifice profile generator 628 is provided as one or more orifice profile instructions to the associated modulating nozzle assembly 640 (or assemblies). As described herein, the orifice profile and the associated orifice profile instructions includes one or more of an orifice size, shape, system pressure (for the system or at a discrete nozzle assembly 640), or the like. The orifice profile instructions are, in one example, provided through a system interface 630, such as a bus, CAN bus, or the like to the associated modulating nozzle assembly 640. The orifice profile instructions are implemented at the assembly 604, for instance one or more actuators and spray tip modulating elements (520, 504 in FIG. 5B), of the assembly 640 modulating either or both of the shuttle edge 510 or base edge 508 to provide the orifice profile 642 of the spray tip that sprays the agricultural product with the specified droplet size and at the specified sprayed flow rate.

In an example of the modulating nozzle control system 600 including generation of system pressure values (e.g., as a component of the orifice profile instruction) the system interface 630 is in communication with a system pressure element 632, such as a system pump, section pump, one or more pressure regulating valves, or the like. Optionally, system pressure may refer to a discrete or local system pressure, for instance an operating pressure at the modulating nozzle assembly 640 (or assemblies) that is controlled with a pressure regulating valve (e.g., operable valve, orifice plate or the like) at the assembly 640 or associated with a subset of assemblies 640 (such as an array or section of modulating nozzle assemblies 640). In these examples, the pressure element 632 is operated to implement the specified system pressure to provide a sprayed flow rate of the agricultural product from the associated one or more modulating nozzle assemblies 640, while the spray tip modulating element 504 controls the droplet size of the sprayed agricultural product (in combination with the system pressure).

As shown in FIG. 6, a spray profile 651 emanates from the modulating nozzle assembly 640. The spray profile 651 is generated with a sprayed flow rate and droplet size based on the orifice profile instructions generated with the modulating nozzle profiler 620. In one example, one or more sensors 650, observe the spray profile 651 and monitor characteristics of the spray profile including kinematics, such as spray pattern, velocity, drift of the sprayed agricultural product, or the like. In other examples, the one or more sensors 650 monitor droplet size and provide measurements indicative for droplet size, such as, one or more of ultra-coarse, coarse, medium, fine, ultra-fine, or the like, including a component analysis of droplets in various sizes (e.g., 60 percent coarse, 20 percent medium, 20 percent ultra-coarse). Optionally, other information is gathered with the one or more sensors 650, such as target height, for instance distance from the target (e.g., canopy) to ground or distance of the target from the modulating nozzle assembly 640. The one or more sensors 650 include one or more cameras, video cameras, lidar, radar, or the like.

Optionally, the one or more sensors 650 include coverage sensors directed toward the crop, such as the canopy, leaves or the like. The coverage sensors, as examples of the sensors 650, monitor performance of the agricultural product such as adhesion of droplets to leaves, coverage area in comparison to leaf area, or the like. In examples including performance feedback 652, as discussed herein, the output of the coverage sensors is provided to the modulating nozzle profiler 620 to permit refinement of one or more of the specified spray profile (e.g., droplet size; spray pattern; boom height, including nozzle height; or the like), specified sprayed flow rate, or the like. For instance, the profiler 620 receiving monitored coverage below a threshold of 50 percent of a leaf implements one or more of a boom height refinement, spray pattern refinement, droplet size refinement (e.g., smaller droplets) to enhance coverage. In another example, if droplet adhesion falls below an adhesion threshold (e.g., a unitless number, droplets per square millimeter or square centimeter, or the like) the profiler 620 initiates a droplet size refinement, for instance from coarse to medium, or medium to fine, to enhance adhesion.

As shown in FIG. 6, the observations of the one or more sensors 650 are provided to the remainder of the modulating nozzle control system 600, such as the modulating nozzle profiler 620, as performance feedback 652. In an example, the performance feedback is compared against one or more of the specified droplet size of the droplet size output 624, the sprayed flow rate from the sprayed flow rate converter 622, or the like, and deviations relative to their respective values are determined. The modulating nozzle profiler 620, such as the sprayed flow rate converter 622, droplet size output 624 or the like further refines (e.g., modifies, changes, or maintains) one or more of the specified spray profile, specified droplet size or the like. The refinements prompt the generation of an orifice profile 626 having one or more of an updated sprayed flow rate, updated droplet size or the like and associated orifice profile instructions that compensate for the determined deviations and accordingly guide performance toward the one or more initially specified droplet size, sprayed flow rate or the like. In this manner, automatic control, including refinement, of the spray profile 651 is conducted to guide performance to specified values for one or more droplet size, sprayed flow rate or the like.

Further, in another example, with performance feedback 652 including target height the modulating nozzle profiler 620 optionally further refines the orifice profile to provide a variation in spray pattern, for instance with an orifice profile instruction that changes the orifice shape of the modulating nozzle assembly 640 at the spray tip. In one example, with a target height between the assembly 640 and a crop canopy greater than a target height threshold a relatively narrow spray pattern is included with the orifice profile instruction to enhance application to the more distant canopy. In another example, with a target height between the assembly 640 and a crop canopy less than the target height threshold a relatively broader spray pattern is included with the orifice profile instructions to enhance coverage of the canopy. In yet another example, specified droplet size is refined according to the observed target height. For instance, with a target height between the nozzle assembly 640 and the canopy less than a target height threshold the specified droplet size is refined to a smaller size (e.g., coarse to medium) to enhance attachment of the droplets to the canopy. Conversely, with a target height greater than the target height threshold the specified droplet size is refined to a larger size (e.g., coarse to ultra-coarse) to decrease spray drift and ensure at least some portion of the sprayed agricultural product reaches the (relatively) distant crop.

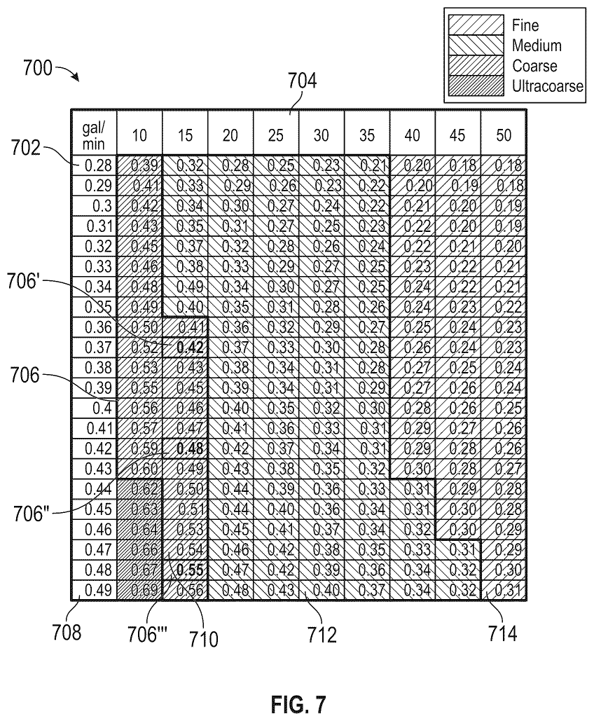

FIG. 7 is an example orifice profile plot 700. The orifice profile plot 700 is one example of the orifice profile generator 628 of FIG. 6. In other examples, the orifice profile plot 700 is instead provided as one or more of an equation, algorithm, or the like. In the example of FIG. 7, the orifice profile plot 700 is interpreted based on inputs including a sprayed flow rate and a specified droplet size. In a similar manner, sprayed flow rate and specified droplet size are inputs in a corresponding equation, algorithm, or the like.

Nozzle flow rates (specified sprayed flow rates) are provided along a vertical axis in the orifice profile plot 700. The nozzle flow rates correspond to a specified sprayed flow rate (gallons per minute or gpm) for one or more modulating nozzle assemblies 640, and as discussed herein, are based at least in part on a field flow rate (gallons per acre, gpa or similar) and the sprayer speed 200, such as one or more of the chassis speed 202, nozzle assembly speed 204, or the like. For instance, as the sprayer 100 is driven faster or slower the nozzle flow rate (specified sprayed flow rate) increases or decreases in a related manner. Accordingly, greater nozzle flow rates in the plot 700 are associated with higher sprayer speed 200 (e.g., of the sprayer itself, speed of the nozzle assemblies, for instance during a turn at a position spaced from the vehicle or virtual pivot along a boom 102).

As flow rate increases or decreases pressure 704 is optionally raised or lowered (e.g., to push the corresponding lower or higher volume of agricultural product). With the modulating nozzle assemblies 604 described herein pressure may be increased (or decreased) or the orifice profile is expanded (or contracted) to permit the delivery of the (increased) flow rate of agricultural product through the nozzle assemblies 604. Accordingly, because pressure is more readily maintained (instead of changed) with a modulating nozzle assembly 604 increased or decreased flow rates do not necessarily push generated droplet sizes outside of specified bands (e.g., such as coarse). Accordingly, the modulating nozzle assemblies and control system 600 permit the maintenance of droplet size even with deviations in sprayed flow rate based on variations in sprayer speed. Further, the modulating nozzle assemblies 604 and control system 600 decrease the need for high pressure pumps because the nozzle assemblies 604 are expandable and contractable to permit application of higher and lower flow rates while attenuating changes in pressure.

As further shown in FIG. 7, the orifice profile plot 700 includes example ultra-coarse, coarse, medium and fine droplet bands 708, 710, 712, 714. As described herein, with agricultural products, field zone based prescriptions or the like having specified spray profiles including specified droplet sizes, the modulating nozzle control system 600 implements the orifice profile plot 700 (in the form of a chart, equation or algorithm) to determine orifice profiles based on sprayer speed, associated sprayed flow rate of the agricultural product, and the specified droplet sizes. For instance, with an agricultural product having a fine droplet profile specification the control system 600 determines sprayed flow rate and orifice profiles within the fine droplet band 714. In another example, with a first field zone based prescription (e.g., for an elevated portion of the field) having a coarse specified droplet size the control system 600 determines sprayed flow rate and orifice profiles within the coarse droplet band 710. Upon transitioning of the sprayer 100 to a second field zone (e.g., for a leeward portion of the field relative to wind direction) a medium droplet size is specified and the control system 600 transitions to determining sprayed flow rates and orifice profiles within the medium droplet band 712. In other examples, refinements are conducted with an input, such as the environment input 610, that adjust a specified droplet size (e.g., from medium to coarse or the like) based on wind speed, direction or the like. The control system 600, for instance with the modulating nozzle profiler 620, transitions determining of sprayed flow rates and orifice profiles from the medium droplet band 712 to the coarse droplet band 710.

The orifice profile plot 700 includes one or more dynamic orifice zones 706 (bolded zones in FIG. 7) that illustrate the performance permutations for one or more modulating nozzle assemblies 604 based on specified spray profile characteristics, such as droplet size, and specified sprayed flow rates. With the modulating nozzle assemblies 604 and the modulating nozzle control system 600 described herein a plurality of specified sprayed flow rates are achievable while also spraying the agricultural product with the specified spray profile characteristics (e.g., a specified droplet size of coarse, medium, fine or the like). As further shown with the orifice profile plot 700 the specified spray profile characteristic, such as droplet size, is maintained with decreased variation in system pressure. For instance, in the dynamic orifice zone 706 shown in FIG. 7 the pressure is varied between 10 and 15 psi while providing a wide range of sprayed flow rates each having coarse droplet sizes when using the modulating nozzle control system 600 with the modulating nozzle assemblies 604. In contrast, as shown in FIG. 4, with a static nozzle variations in sprayed flow rate 402 include corresponding increases in pressure that push the nozzle performance from the specified coarse droplet size with into medium droplet sizes outside of the specification. The control system 600 and associated modulating nozzle assemblies 604 permit variation in sprayed flow rate with attenuated changes (including no change) in pressure while maintaining a specified spray profile, such as droplet size.

The dynamic orifice zone 706 includes example permutations of sprayer settings for the modulating nozzle assemblies 604 implemented with the modulating nozzle control system 600 that provide specified sprayed flow rates and specified spray profiles, such as droplet sizes. As shown the dynamic orifice zone 706 corresponds with the coarse droplet band 710 of the orifice profile plot 700.

Accordingly, as the sprayer speed increases or decreases, the sprayed flow rate is adjusted as is the orifice profile within the band 710 to spray the agricultural product with the specified coarse droplet size while varying sprayed flow rates to achieve specified sprayed flow rates. In the example dynamic orifice zone 706 the modulating orifice profiles of 0.39 to 0.56 mm are provided that maintain a specified droplet size (coarse) while the nozzle flow rate 702 (sprayed flow rate) changes. Control of the modulating nozzle assemblies 604 with the modulating nozzle control system 600 permits the maintenance of a specified droplet size even while flow rate is varied at the nozzle assemblies. Additionally, changes in pressure (that may frustrate maintenance of droplet size) are optional in contrast to being required in some example static nozzles.

In a first example dynamic orifice position 706′, with an initial sprayer speed of 12 mph the resulting nozzle flow rate (specified sprayed flow rate) is 0.37 gallons per minute. At this flow rate and with a pressure of 15 psi and a modulating nozzle size of 0.42 mm, coarse droplets are sprayed as specified from the modulating nozzle assembly 604. As the operator drives the sprayer at a greater speed (e.g., 15 mph) corresponding to the second example dynamic orifice position 706″ of the zone 706, the nozzle flow rate is correspondingly increased to 0.42 gpm. Because the modulating nozzle assembly 604 is provided the pressure remains relatively static (is not raised or is raised to a lesser degree than in the example shown in FIG. 4). The orifice profile of the modulating nozzle assembly 604 is expanded to 0.48 mm (from 0.42 mm), and accordingly as shown, the droplets generated from the expanded nozzle remain the specified coarse droplet size. In a third example dynamic orifice position 706″′ the sprayer 100 is driven at a greater speed, 20 mph, with an associated sprayed flow rate of 0.48 gpm. The orifice profile of 0.55 mm at this position 706″′ permits the spraying of the agricultural product with the modulating nozzle assembly 604 at the specified coarse droplet size while also applying the product with the specified sprayed flow rate.

As shown, at greater speeds of the sprayer 100 the nozzle flow rate (sprayed nozzle flow rate) increases while pressure is maintained (or raised a smaller value relative to the static nozzle example). Accordingly, even with the increases in nozzle flow rate because of speed the specified droplet size is maintained with further increase of the modulating nozzle. The modulating nozzle and control of the same permits separation of flow rate from pressure to thereby permit achieving of specified droplet size with a variety of nozzle flow rates.

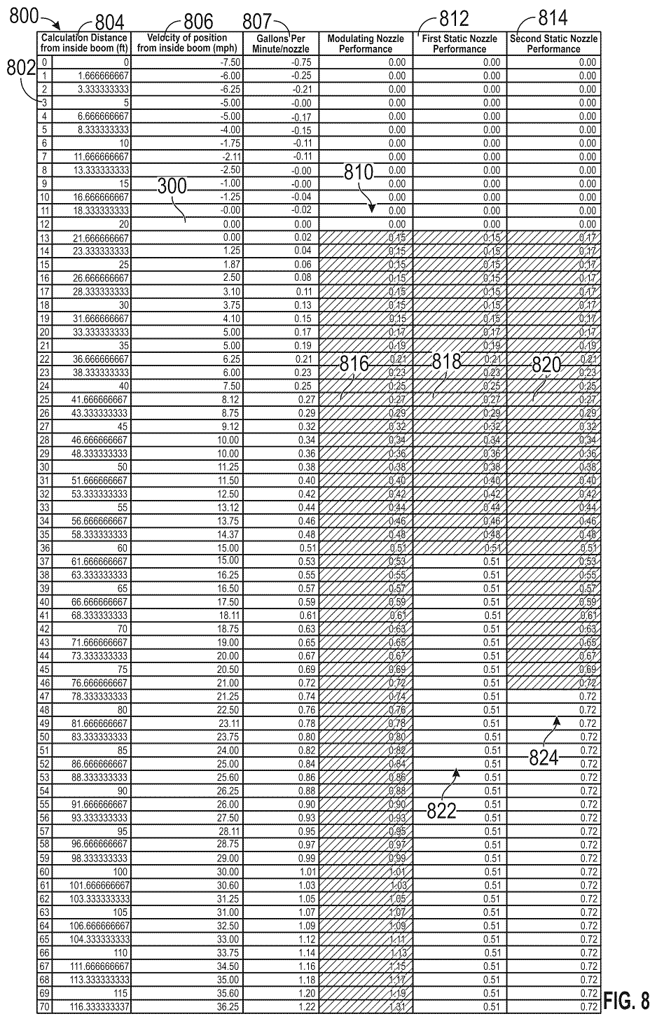

Referring now to FIG. 8, a specified versus actual sprayed flow rate plot 800 is provided that illustrates nozzle performance between example static nozzle performance 812, 814 and a modulating nozzle performance 810, for example provided with the modulating nozzle control system 600 and modulating nozzle assemblies 604 described herein. The static nozzle performances 812, 814 and modulating nozzle performance 810 are illustrated with a plurality of nozzle assemblies identified with the nozzle index 802 (e.g., 0 to 70) corresponding to 70 nozzle assemblies provided at a distal end of a first sprayer boom (e.g., nozzle 0) to a distal end of a second sprayer boom (e.g., nozzle 70). The nozzle location 804 column provides numerical values, or spacing, of the indexed nozzles from nozzle 0. For instance, nozzle 1 is spaced 1.67 feet from nozzle 0, nozzle 12 is spaced 20feet from nozzle 0, and so on.

As further shown in FIG. 8, the speed of the nozzle assemblies 806 are shown in the third column of the plot 800. As shown in this example the example sprayer is conducting a turn while also traveling in a forward direction. Accordingly, the indexed nozzles have a chassis speed 202 component and a nozzle assembly speed 204 component to composite agricultural sprayer speeds 200. Referring to FIG. 3, the virtual pivot point 300 having an agricultural sprayer speed 200 of zero mph is reflected in the plot 800 as corresponding to indexed nozzles 11-13. The indexed nozzles 0-10 have negative sprayer speeds 200 indicating the associated portion of the sprayer boom 102 (the left most portion of the left boom 102 in FIG. 3) is moving relatively backward. Conversely, the indexed nozzles 14-70 have (positive) escalating speed values corresponding to the additive components of the chassis speed 202 and the various nozzle assembly speeds 204 shown in FIG. 3 (see increasing arrow magnitudes) and shown in FIG. 8 with the increasing nozzle assembly speed values.

FIG. 8 further illustrates specified sprayed flow rates 807 for the indexed nozzles 802 in units of gallons per minute (gpm). As previously discussed, the sprayed flow rate is generated from the field flow rate (e.g., gallons per acre or gpa) and the agricultural sprayer speed 200. In this example of a turn illustrated in FIG. 8 each nozzle assembly has a varied speed, see 806, based on the chassis speed 202 of the agricultural sprayer and the rotational movement for each nozzle assembly (nozzle assembly speed 204). Because indexed nozzle 12 corresponds to the turn center it has a velocity of 0 mph and its associated sprayed flow rate 807 is 0.00 gpm. The sprayed flow rates 807 for each of the nozzle assemblies is determined from the field flow rate (gpa) and the agricultural sprayer speed 806 for the respective nozzle assembly. The nozzles from the turn virtual pivot point (e.g., nozzle 12) to the outer most nozzle (nozzle 70) have gradually greater speeds, and accordingly greater sprayed flow rates 807. Conversely, the inner nozzles from nozzle 12 to nozzle 0 have negative speeds (or 0 mph) and are moving backward over treated portions of the field or are static. Accordingly, the sprayed flow rates for the inner nozzles are set to 0 gpm to avoid over application.

Referring now to the static nozzle examples 812, 814, associated performance zones 818, 820 are provided for each of the examples. As previously discussed, because static nozzles are used in these examples pressure is raised to increase sprayed flow rates. In a first example, the static nozzle example 812, the performance zone 818 increases sprayed flow rates according to the corresponding speeds 806 of the indexed nozzles, from indexed nozzle 13 to indexed nozzle 37. As shown, the sprayed flow rate increases from a lesser value of 0.15 gpm (nozzle 13) to a greater value of 0.51 gpm (nozzle 36). However, after nozzle 36, from nozzles 37 to 70 the nozzle performance crosses into a deadheading zone 822 wherein the sprayed flow rate fails to increase in keeping the increasing speeds of nozzles 37 to 70. In this example, further increases of system pressure in the sprayer 100 fail to correspondingly increase the sprayed flow rate because the static nozzle cannot fluidly accommodate the increased flow rate. Accordingly, the static nozzle example 812 ‘deadheads’. The nozzle assemblies 37 to 70 accordingly fail to spray the agricultural product at a sprayed flow rate commensurate with the nozzle speeds 806 and the targets (e.g., a field zone) covered by those nozzles do not receive the specified quantity of the agricultural product. Further, because pressure escalates while using static nozzles the droplet sizes may also decrease outside of specification (e.g., from coarse to medium, fine, ultrafine or the like) for the agricultural product, prescription, weather conditions, or the like.

Another second static nozzle example 814 is illustrated adjacent to the first example 812. In this example, the performance zone 820 is relatively larger in comparison to the comparison zone 818. For instance, the static nozzles in this example are relatively larger in comparison to the first example 812. For example various sprayed flow rates are shown for nozzles 13 to 45. However, similar to the first example 812, the second example includes a deadheading zone 824 that begins at nozzle 47 having a sprayed flow rate of 0.72 gpm identical to the sprayed flow rate of nozzle 46, thereby indicating at nozzle speeds greater than 21.00 mph the sprayer fails to apply the agricultural product at a sprayed flow rate commensurate with the nozzle speeds. Additionally, because pressure escalates the sprayed droplets in this deadheading zone 824 may also move outside of specification for the agricultural product, prescription, weather conditions, or the like.

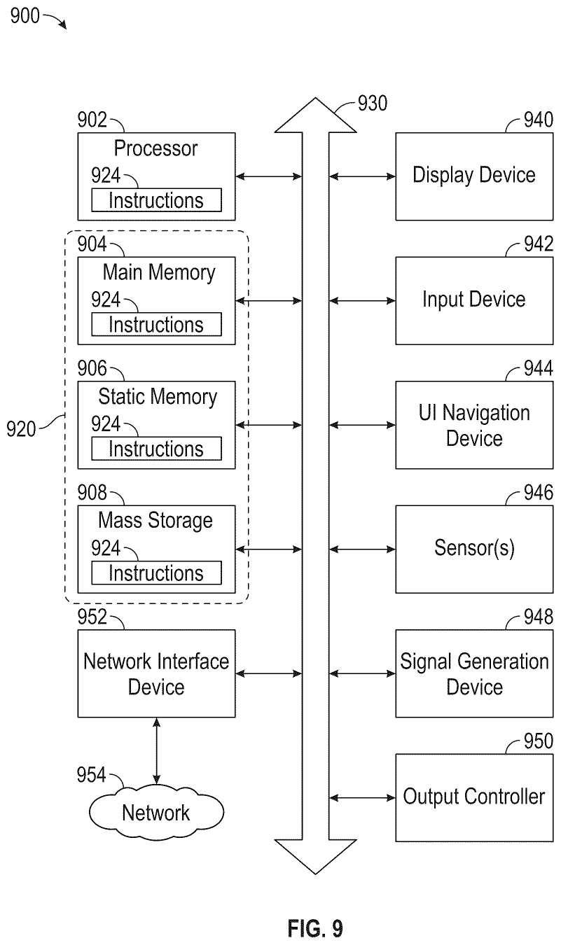

The techniques shown and described in this document are performed in various examples using a portion or an entirety of a modulating nozzle control system 600, modulating nozzle assemblies 604 (including other examples described herein, such as assemblies 106, 500), or the like as described herein or otherwise using a machine 900 as discussed below in relation to FIG. 9. FIG. 9 illustrates a block diagram of an example comprising a machine 900 upon which any one or more of the techniques (e.g., methodologies) discussed herein is performed. In various examples, the machine 900 operates as a standalone device or is connected (e.g., networked) to other machines.

In a networked deployment, the machine 900 operates in the capacity of a server machine, a client machine, or both in server-client network environments. In an example, the machine 900 acts as a peer machine in peer-to-peer (P2P) (or other distributed) network environments. The machine 900 is optionally a personal computer (PC), a tablet device, a set-top box (STB), a personal digital assistant (PDA), a mobile telephone, a web appliance, a network router, switch or bridge, field computer, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate by, logic or a number of components, or mechanisms. Circuitry is a collection of circuits implemented in tangible entities that include hardware (e.g., simple circuits, gates, logic, etc.). Circuitry membership is flexible over time and underlying hardware variability. Circuitries include members that, alone or in combination, perform specified operations when operating. In an example, hardware of the circuitry is immutably designed to carry out a specific operation (e.g., hardwired). In another example, the hardware comprising the circuitry includes variably connected physical components (e.g., execution units, transistors, simple circuits, or the like) including a computer-readable medium physically modified (e.g., magnetically, electrically, such as via a change in physical state or transformation of another physical characteristic, or the like) to encode instructions of the specific operation. In connecting the physical components, the underlying electrical properties of a hardware constituent are changed, for example, from an insulating characteristic to a conductive characteristic or vice versa. The instructions enable embedded hardware (e.g., the execution units or a loading mechanism) to create members of the circuitry in hardware via the variable connections to carry out portions of the specific operation when in operation. Accordingly, the computer-readable medium is communicatively coupled to the other components of the circuitry when the device is operating. In an example, any of the physical components are used in more than one member of more than one circuitry. For example, under operation, execution units may be used in a first circuit of a first circuitry at one point in time and reused by a second circuit in the first circuitry, or by a third circuit in a second circuitry at a different time.

The machine 900 (e.g., computer system) may include a hardware-based processor 902 (e.g., a central processing unit (CPU), a graphics processing unit (GPU), a hardware processor core, or any combination thereof), a main 904 and a static memory 906, some or all of which may communicate with each other via an interlink 930 (e.g., a bus, CAN bus or the like). The machine 900 may further include a display device 940, an input device 942 (e.g., an alphanumeric keyboard), and a user interface (UI) navigation device 944 (e.g., a mouse, track pad, track ball, stylus, or the like). In an example, the display device 940, the input device 942, and the UI navigation device 944 comprise at least portions of a touch screen display. The machine 900 may additionally include a storage device 920 (e.g., a drive unit), a signal generation device 948 (e.g., a speaker, light system, or the like), a network interface device 950, and one or more sensors 946, such as a global positioning system (GPS) sensor, compass, accelerometer, or other sensor, such as the sensors described herein. The machine 900 includes, in an example, an output controller 950, such as a serial controller or interface (e.g., a universal serial bus (USB)), a parallel controller or interface, or other wired or wireless (e.g., infrared (IR) controllers or interfaces, near field communication (NFC), etc., coupled to communicate or control one or more peripheral devices (e.g., a printer, a card reader, etc.).

The storage device 920 includes, but is not limited to, a machine readable medium on which is stored one or more sets of data structures or instructions 924 (e.g., software or firmware) embodying or utilized by any one or more of the techniques or functions described herein including, but not limited to, the modulating nozzle control system 600, modulating nozzle profiler 620, orifice profile generator 628, or the like. The instructions 924 may also reside, completely or at least partially, within a main memory 904, within a static memory 906, within a mass storage device 908, or within the hardware-based processor 902 during execution thereof by the machine 900. In an example, one or any combination of the hardware-based processor 902, the main memory 904, the static memory 906, the mass storage 908, or the storage device 920 may constitute machine readable media.

While the machine readable medium is in one example considered as a single medium, the term “machine readable medium” may include a single medium or multiple media (e.g., a centralized or distributed database, and/or associated caches and servers) configured to store the one or more instructions 924.

The term “machine readable medium” may include any medium that is capable of storing, encoding, or carrying instructions for execution by the machine 900 and that cause the machine 900 to perform any one or more of the techniques of the present disclosure, or that is capable of storing, encoding or carrying data structures used by or associated with such instructions. Non-limiting machine-readable medium examples may include solid-state memories, and optical and magnetic media. Accordingly, machine-readable media are not transitory propagating signals. Specific examples of massed machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic or other phase-change or state-change memory circuits; magnetic disks, such as internal hard disks and removable disks; magneto-optical disks; and CD-ROM and DVD-ROM disks.

The instructions 924 may further be transmitted or received over a communications network 954 using a transmission medium via the network interface device 952 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., the Institute of Electrical and Electronics Engineers (IEEE) 802.22 family of standards known as Wi-Fi®, the IEEE 802.26 family of standards known as WiMax®), the IEEE 802.27.4 family of standards, peer-to-peer (P2P) networks, among others. In an example, the network interface device 952 may include one or more physical jacks (e.g., Ethernet, coaxial, or phone jacks) or one or more antennas to connect to the communications network 954. In an example, the network interface device 952 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 900, and includes digital or analog communications signals or other intangible medium to facilitate communication of such software.

### Various Notes and Aspects

Aspect 1 can include subject matter such as a modulating nozzle control system for an agricultural sprayer, the modulating nozzle control system comprising: one or more modulating nozzle assemblies, the one or more modulating nozzle assemblies each include: a spray tip modulating element at a spray tip having an orifice profile; an actuator operatively coupled with the spay tip modulating element; and wherein the spray tip modulating element is configured to control the orifice profile; and a processor system configured to control the orifice profiles of the one or more modulating nozzle assemblies, the processor system includes: an agricultural product input configured to receive a specified field flow rate and a specified droplet size for an agricultural product; a sprayer speed input configured to receive an agricultural sprayer speed; a modulating nozzle profiler in communication with the agricultural product input, the sprayer speed input and the one or more modulating nozzle assemblies, the modulating nozzle profiler includes: an orifice profile generator configured to generate an orifice profile instruction based on the specified field flow rate, the agricultural sprayer speed and the specified droplet size; and wherein the spray tip modulating element and the actuator are configured to control the orifice profile according to the orifice profile instruction to achieve the specified droplet size.

Aspect 2 can include, or can optionally be combined with the subject matter of Aspect 1, to optionally include wherein the spray tip modulating element and the actuator are configured to control the orifice profile according to the orifice profile instruction to achieve the specified droplet size with variation of the agricultural sprayer speed.

Aspect 3 can include, or can optionally be combined with the subject matter of one or any combination of Aspects 1 or 2 to optionally include wherein the sprayer speed input configured to receive the agricultural sprayer speed includes the sprayer speed input configured to receive a sprayer chassis speed and one or more nozzle assembly speeds of the respective one or more modulating nozzle assemblies.

Aspect 4 can include, or can optionally be combined with the subject matter of one or any combination of Aspects 1-3 to optionally include wherein the orifice profile generator is configured to generate the orifice profile instruction based on the specified field flow rate, the sprayer chassis speed, the one or more nozzle assembly speeds, and the specified droplet size.

Aspect 5 can include, or can optionally be combined with the subject matter of one or any combination of Aspects 1-4 to optionally include wherein the processor system includes a sprayed flow rate converter configured to determine a sprayed flow rate for the one or more modulating nozzle assemblies based on the specified field flow rate and the agricultural sprayer speed; and the orifice profile generator configured to generate the orifice profile instruction based on the specified field flow rate, the agricultural sprayer speed and the specified droplet size is configured to generate the orifice profile instruction based on the sprayed flow rate and the specified droplet size.

Aspect 6 can include, or can optionally be combined with the subject matter of Aspects 1-5 to optionally include wherein the modulating nozzle profiler includes a pressure setting generator configured to generate a pressure setting instruction based on the specified field flow rate, the agricultural sprayer speed and the specified droplet size.

Aspect 7 can include, or can optionally be combined with the subject matter of Aspects 1-6 to optionally include wherein a pressure element is configured to control a system pressure according to the pressure setting instruction to maintain the specified droplet size.

Aspect 8 can include, or can optionally be combined with the subject matter of Aspects 1-7 to optionally include wherein the orifice profile generator includes one or more of a chart, algorithm or equation.

Aspect 9 can include, or can optionally be combined with the subject matter of Aspects 1-8 to optionally include wherein the one or more modulating nozzle assemblies each includes a nozzle base; the spray tip modulating element includes a shuttle movably coupled with the nozzle base.

Aspect 10 can include, or can optionally be combined with the subject matter of Aspects 1-9 to optionally include wherein the nozzle base includes a base edge of the orifice profile, and the shuttle includes a shuttle edge of the orifice profile.

Aspect 11 can include, or can optionally be combined with the subject matter of Aspects 1-10 to optionally include wherein the one or more modulating nozzle assemblies includes a plurality of modulating nozzle assemblies.

Aspect 12 can include, or can optionally be combined with the subject matter of Aspects 1-11 to optionally include wherein the processor system includes at least one processor in communication with a respective modulating nozzle assembly of the plurality of modulating nozzle assemblies.

Aspect 13 can include, or can optionally be combined with the subject matter of Aspects 1-12 to optionally include wherein the processing system includes one or more processors.

Aspect 14 can include, or can optionally be combined with the subject matter of Aspects 1-13 to optionally include one or more performance sensors in communication with the modulating nozzle profiler, the one or performance sensors configured to monitor the one or more modulating nozzle assemblies or spray patterns emanated from the one or more modulating nozzle assemblies; wherein the modulating nozzle profiler is configured to modify the orifice profile instruction based on one or more of the monitored spray patterns or monitored one or more modulating nozzle assemblies.

Aspect 15 can include, or can optionally be combined with the subject matter of Aspects 1-14 to optionally include wherein the one or more performance sensors include one or more cameras directed at spray patterns emanated from the one or more modulating nozzle assemblies.

Aspect 16 can include, or can optionally be combined with the subject matter of Aspects 1-15 to optionally include a modulating nozzle control system for an agricultural sprayer, the modulating nozzle controller comprising: one or more modulating nozzle assemblies, the one or more modulating nozzle assemblies each include: a spray tip modulating element at a spray tip having an orifice profile; and wherein the spray tip modulating element is configured to control the orifice profile; a processor system configured to control the orifice profiles of the one or more modulating nozzle assemblies, the processor system includes: an agricultural product input configured to receive a specified field flow rate and a specified droplet size for an agricultural product; a sprayer speed input configured to receive an agricultural sprayer speed, the agricultural sprayer speed including at least a first agricultural sprayer speed and a second agricultural sprayer speed different from the first agricultural sprayer speed; a modulating nozzle profiler in communication with the agricultural product input, the sprayer speed input and the one or more modulating nozzle assemblies, the modulating nozzle profiler configured to: generate a first orifice profile instruction based on the specified field flow rate, the first agricultural sprayer speed and the specified droplet size; and generate a second orifice profile instruction based on the specified field flow rate, the second agricultural sprayer speed and the specified droplet size; wherein the spray tip modulating element is configured to control the orifice profile to a first orifice profile based on the first orifice profile instruction; and wherein the spray tip modulating element is configured to control the orifice profile to a second orifice profile based on the second orifice profile instruction.

Aspect 17 can include, or can optionally be combined with the subject matter of Aspects 1-16 to optionally include wherein the spray tip modulating element is configured to control the orifice profile to a first orifice profile based on the first orifice profile instruction to achieve the specified droplet size; and wherein the spray tip modulating element is configured to control the orifice profile to a second orifice profile based on the second orifice profile instruction to achieve the specified droplet size.

Aspect 18 can include, or can optionally be combined with the subject matter of Aspects 1-17 to optionally include wherein the processor system includes one or more of: a system input configured to receive one or more of modulating nozzle characteristics of the one or more modulating nozzles assemblies, system pressure range, or speed range of the agricultural sprayer; a prescription map input configured to receive a prescription map having one or more of droplet size modifications or field flow rate modifications; an environment input configured to receive one or more of agricultural sprayer position, wind speed, wind direction, humidity, or temperature.

Aspect 19 can include, or can optionally be combined with the subject matter of Aspects 1-18 to optionally include wherein the modulating nozzle profiler is configured to modify one or more of the first or second orifice profile instructions based on one or more of droplet size modifications, wind speed, wind direction, humidity or temperature.

Aspect 20 can include, or can optionally be combined with the subject matter of Aspects 1-19 to optionally include wherein the modulating nozzle profiler is configured to modify first or second sprayed flow rates associated with the respective first or second orifice profile instructions based on the field flow rate modifications, agricultural sprayer position, wind speed, or wind direction.

Aspect 21 can include, or can optionally be combined with the subject matter of Aspects 1-20 to optionally include wherein the processor system includes a sprayed flow rate converter configured to determine first and second sprayed flow rates for the one or more modulating nozzle assemblies based on the specified field flow rate and the first and second agricultural sprayer speeds, respectively; and the modulating nozzle profiler is configured to generate the first orifice profile instruction and the second orifice profile instruction based on the first and second sprayed flow rates, respectively, and the specified droplet size.

Aspect 22 can include, or can optionally be combined with the subject matter of Aspects 1-21 to optionally include wherein the modulating nozzle profiler is configured to generate a first pressure setting instruction and a second pressure setting instruction based on the specified field flow rate, the first and second agricultural sprayer speeds, respectively, and the specified droplet size.

Aspect 23 can include, or can optionally be combined with the subject matter of Aspects 1-22 to optionally include wherein a pressure element is configured to control a system pressure according to one of the first or second pressure setting instructions to maintain the specified droplet size.

Aspect 24 can include, or can optionally be combined with the subject matter of Aspects 1-23 to optionally include wherein the modulating nozzle profiler includes one or more of a chart, algorithm or equation for generating the first and second orifice profile instructions.

Aspect 25 can include, or can optionally be combined with the subject matter of Aspects 1-24 to optionally include wherein the one or more modulating nozzle assemblies each includes a nozzle base; the spray tip modulating element includes a shuttle movably coupled with the nozzle base.

Aspect 26 can include, or can optionally be combined with the subject matter of Aspects 1-25 to optionally include wherein the one or more modulating nozzle assemblies includes a plurality of modulating nozzle assemblies.

Aspect 27 can include, or can optionally be combined with the subject matter of Aspects 1-26 to optionally include a method for controlling one or more modulating nozzle assemblies of an agricultural sprayer comprising: receiving a specified field flow rate and a specified droplet size for an agricultural product; monitoring an agricultural sprayer speed, wherein the agricultural sprayer speed is dynamic; determining one or more instructions for control of the one or more modulating nozzle assemblies, determining the one or more instructions includes: generating an orifice profile instruction based on the specified field flow rate, the specified droplet size and the monitored agricultural sprayer speed; controlling the one or more modulating nozzle assemblies, controlling includes: actuating one or more spray tip modulating elements according to the orifice profile instruction, the one or more spray tip modulating elements associated with the one or more modulating nozzle assemblies; and modulating one or more orifice profiles according to the actuating of the one or more spray tip modulating elements; and spraying the agricultural product from the one or more modulating nozzle assemblies with the specified droplet size according to the modulated one or more orifice profiles.

Aspect 28 can include, or can optionally be combined with the subject matter of Aspects 1-27 to optionally include determining a sprayed flow rate of the agricultural product for the one or more modulating nozzle assemblies, the sprayed flow rate based on the specified field flow rate and the monitored agricultural sprayer speed.

Aspect 29 can include, or can optionally be combined with the subject matter of Aspects 1-28 to optionally include wherein generating the orifice profile instruction based on the specified field flow rate, the specified droplet size and the monitored agricultural sprayer speed includes generating the orifice profile instruction based on the sprayed flow rate and the specified droplet size.

Aspect 30 can include, or can optionally be combined with the subject matter of Aspects 1-29 to optionally include wherein spraying the agricultural product from the one or more modulating nozzle assemblies with the specified droplet size according to the modulated one or more orifice profiles includes spraying the agricultural product from the one or more modulating nozzle assemblies with the specified droplet size while varying the agricultural sprayer speed and the corresponding sprayed flow rate for the one or more modulating nozzle assemblies.

Aspect 31 can include, or can optionally be combined with the subject matter of Aspects 1-30 to optionally include wherein determining the one or more instructions for control of the one or more modulating nozzle assemblies includes: generating a pressure instruction based on the specified field flow rate, the specified droplet size and the monitored agricultural sprayer speed.

Aspect 32 can include, or can optionally be combined with the subject matter of Aspects 1-31 to optionally include controlling a system pressure according to the pressure instruction to achieve the specified droplet size.

Aspect 33 can include, or can optionally be combined with the subject matter of Aspects 1-32 to optionally include wherein generating the orifice profile instruction based on the specified field flow rate, the specified droplet size and the monitored agricultural sprayer speed includes implementing one or more of a chart, algorithm or equation.

Aspect 34 can include, or can optionally be combined with the subject matter of Aspects 1-33 to optionally include wherein the one or more modulating nozzle assemblies each include a nozzle base and a shuttle movably coupled with the nozzle base; and actuating the one or more spray tip modulating elements according to the orifice profile instruction includes moving the shuttle relative to the nozzle base to set the one or more orifice profiles according to the orifice profile instruction.

Aspect 35 can include, or can optionally be combined with the subject matter of Aspects 1-34 to optionally include wherein monitoring the agricultural sprayer speed includes monitoring one or more of a sprayer chassis speed or one or more nozzle assembly speeds.

Aspect 36 can include, or can optionally be combined with the subject matter of Aspects 1-35 to optionally include wherein monitoring the agricultural sprayer speed includes monitoring one or more different nozzle assembly speeds.

Aspect 37 can include, or can optionally be combined with the subject matter of Aspects 1-36 to optionally include determining a sprayed flow rate of the agricultural product for the one or more modulating nozzle assemblies, the sprayed flow rate based on the specified field flow rate and the one or more different nozzle assembly speeds.

Each of these non-limiting aspects can stand on its own, or can be combined in various permutations or combinations with one or more of the other aspects.

The above description includes references to the accompanying drawings, which form a part of the detailed description. The drawings show, by way of illustration, specific embodiments in which the invention can be practiced. These embodiments are also referred to herein as “aspects” or “examples.” Such aspects or example can include elements in addition to those shown or described. However, the present inventors also contemplate aspects or examples in which only those elements shown or described are provided. Moreover, the present inventors also contemplate aspects or examples using any combination or permutation of those elements shown or described (or one or more features thereof), either with respect to a particular aspects or examples (or one or more features thereof), or with respect to other Aspects (or one or more features thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Geometric terms, such as “parallel”, “perpendicular”, “round”, or “square”, are not intended to require absolute mathematical precision, unless the context indicates otherwise. Instead, such geometric terms allow for variations due to manufacturing or equivalent functions. For example, if an element is described as “round” or “generally round,” a component that is not precisely circular (e.g., one that is slightly oblong or is a many-sided polygon) is still encompassed by this description.

Method aspects or examples described herein can be machine or computer-implemented at least in part, for instance with one or more processors, associated memory, input and output devices. Some aspects or examples can include a computer-readable medium or machine-readable medium encoded with instructions operable to configure an electronic device to perform methods as described in the above aspects or examples. An implementation of such methods can include code, circuits, code modules, software modules, hardware modules or the like, such as or having microcode, assembly language code, a higher-level language code, hardwiring or the like. Such code can include computer readable instructions for performing various methods. The code may form portions of computer program products or is included in controllers, programmable logic controllers or the like having modules (e.g., circuits, software, subunits or the like) configured to implement the code and perform the various methods. Further, in an aspect or example, the code can be tangibly stored on one or more volatile, non-transitory, or non-volatile tangible computer-readable media, such as during execution or at other times. Aspects or examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), circuits and the like.

The above description is intended to be illustrative, and not restrictive. For example, the above-described aspects or examples (or one or more aspects thereof) may be used in combination with each other. Other embodiments can be used, such as by one of ordinary skill in the art upon reviewing the above description. The Abstract is provided to comply with 37 C.F.R. § 1.72 (b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as aspects, examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

1. A modulating nozzle control system for an agricultural sprayer, the modulating nozzle control system comprising:
one or more modulating nozzle assemblies, the one or more modulating nozzle assemblies each include:
a spray tip modulating element at a spray tip having an orifice profile;
an actuator operatively coupled with the spay tip modulating element; and
wherein the spray tip modulating element is configured to control the orifice profile; and
a processor system configured to control the orifice profiles of the one or more modulating nozzle assemblies, the processor system includes:
an agricultural product input configured to receive a specified field flow rate and a specified droplet size for an agricultural product;
a sprayer speed input configured to receive an agricultural sprayer speed;
a modulating nozzle profiler in communication with the agricultural product input, the sprayer speed input and the one or more modulating nozzle assemblies, the modulating nozzle profiler includes:
an orifice profile generator configured to generate an orifice profile instruction based on the specified field flow rate, the agricultural sprayer speed and the specified droplet size; and
wherein the spray tip modulating element and the actuator are configured to control the orifice profile according to the orifice profile instruction to achieve the specified droplet size.

2. The modulating nozzle control system of claim 1, wherein the spray tip modulating element and the actuator are configured to control the orifice profile according to the orifice profile instruction to achieve the specified droplet size with variation of the agricultural sprayer speed.

3. The modulating nozzle control system of claim 1, wherein the sprayer speed input configured to receive the agricultural sprayer speed includes the sprayer speed input configured to receive a sprayer chassis speed and one or more nozzle assembly speeds of the respective one or more modulating nozzle assemblies.

4. The modulating nozzle control system of claim 3, wherein the orifice profile generator is configured to generate the orifice profile instruction based on the specified field flow rate, the sprayer chassis speed, the one or more nozzle assembly speeds, and the specified droplet size.

5. The modulating nozzle control system of claim 1, wherein the processor system includes a sprayed flow rate converter configured to determine a sprayed flow rate for the one or more modulating nozzle assemblies based on the specified field flow rate and the agricultural sprayer speed; and
the orifice profile generator configured to generate the orifice profile instruction based on the specified field flow rate, the agricultural sprayer speed and the specified droplet size is configured to generate the orifice profile instruction based on the sprayed flow rate and the specified droplet size.

6. The modulating nozzle control system of claim 1, wherein the modulating nozzle profiler includes a pressure setting generator configured to generate a pressure setting instruction based on the specified field flow rate, the agricultural sprayer speed and the specified droplet size.

7. The modulating nozzle control system of claim 6, wherein a pressure element is configured to control a system pressure according to the pressure setting instruction to maintain the specified droplet size.

8. The modulating nozzle control system of claim 1, wherein the orifice profile generator includes one or more of a chart, algorithm or equation.

9. The modulating nozzle control system of claim 1, wherein the one or more modulating nozzle assemblies each includes a nozzle base;
the spray tip modulating element includes a shuttle movably coupled with the nozzle base.

10. The modulating nozzle control system of claim 9, wherein the nozzle base includes a base edge of the orifice profile, and the shuttle includes a shuttle edge of the orifice profile.

11. The modulating nozzle control system of claim 1, wherein the one or more modulating nozzle assemblies includes a plurality of modulating nozzle assemblies.

12. The modulating nozzle control system of claim 11, wherein the processor system includes at least one processor in communication with a respective modulating nozzle assembly of the plurality of modulating nozzle assemblies.

13. The modulating nozzle control system of claim 1, wherein the processing system includes one or more processors.

14. The modulating nozzle control system of claim 1 comprising one or more performance sensors in communication with the modulating nozzle profiler, the one or performance sensors configured to monitor the one or more modulating nozzle assemblies or spray patterns emanated from the one or more modulating nozzle assemblies;
wherein the modulating nozzle profiler is configured to modify the orifice profile instruction based on one or more of the monitored spray patterns or monitored one or more modulating nozzle assemblies.

15. The modulating nozzle control system of claim 14, wherein the one or more performance sensors include one or more cameras directed at spray patterns emanated from the one or more modulating nozzle assemblies.

16. A modulating nozzle control system for an agricultural sprayer, the modulating nozzle controller comprising:
one or more modulating nozzle assemblies, the one or more modulating nozzle assemblies each include:
a spray tip modulating element at a spray tip having an orifice profile; and
wherein the spray tip modulating element is configured to control the orifice profile;
a processor system configured to control the orifice profiles of the one or more modulating nozzle assemblies, the processor system includes:
an agricultural product input configured to receive a specified field flow rate and a specified droplet size for an agricultural product;
a sprayer speed input configured to receive an agricultural sprayer speed, the agricultural sprayer speed including at least a first agricultural sprayer speed and a second agricultural sprayer speed different from the first agricultural sprayer speed;
a modulating nozzle profiler in communication with the agricultural product input, the sprayer speed input and the one or more modulating nozzle assemblies, the modulating nozzle profiler configured to:
generate a first orifice profile instruction based on the specified field flow rate, the first agricultural sprayer speed and the specified droplet size; and
generate a second orifice profile instruction based on the specified field flow rate, the second agricultural sprayer speed and the specified droplet size;
wherein the spray tip modulating element is configured to control the orifice profile to a first orifice profile based on the first orifice profile instruction; and
wherein the spray tip modulating element is configured to control the orifice profile to a second orifice profile based on the second orifice profile instruction.

17. The modulating nozzle control system of claim 16, wherein the spray tip modulating element is configured to control the orifice profile to a first orifice profile based on the first orifice profile instruction to achieve the specified droplet size; and
wherein the spray tip modulating element is configured to control the orifice profile to a second orifice profile based on the second orifice profile instruction to achieve the specified droplet size.

18. The modulating nozzle control system of claim 16, wherein the processor system includes one or more of:
a system input configured to receive one or more of modulating nozzle characteristics of the one or more modulating nozzles assemblies, system pressure range, or speed range of the agricultural sprayer;
a prescription map input configured to receive a prescription map having one or more of droplet size modifications or field flow rate modifications;
an environment input configured to receive one or more of agricultural sprayer position, wind speed, wind direction, humidity, or temperature.

19. The modulating nozzle control system of claim 18, wherein the modulating nozzle profiler is configured to modify one or more of the first or second orifice profile instructions based on one or more of droplet size modifications, wind speed, wind direction, humidity or temperature.

20. The modulating nozzle control system of claim 18, wherein the modulating nozzle profiler is configured to modify first or second sprayed flow rates associated with the respective first or second orifice profile instructions based on the field flow rate modifications, agricultural sprayer position, wind speed, or wind direction.

21. The modulating nozzle control system of claim 16, wherein the processor system includes a sprayed flow rate converter configured to determine first and second sprayed flow rates for the one or more modulating nozzle assemblies based on the specified field flow rate and the first and second agricultural sprayer speeds, respectively; and
the modulating nozzle profiler is configured to generate the first orifice profile instruction and the second orifice profile instruction based on the first and second sprayed flow rates, respectively, and the specified droplet size.

22. The modulating nozzle control system of claim 16, wherein the modulating nozzle profiler is configured to generate a first pressure setting instruction and a second pressure setting instruction based on the specified field flow rate, the first and second agricultural sprayer speeds, respectively, and the specified droplet size.

23. The modulating nozzle control system of claim 22, wherein a pressure element is configured to control a system pressure according to one of the first or second pressure setting instructions to maintain the specified droplet size.

24. The modulating nozzle control system of claim 16, wherein the modulating nozzle profiler includes one or more of a chart, algorithm or equation for generating the first and second orifice profile instructions.

25. The modulating nozzle control system of claim 16, wherein the one or more modulating nozzle assemblies each includes a nozzle base;
the spray tip modulating element includes a shuttle movably coupled with the nozzle base.

26. The modulating nozzle control system of claim 16, wherein the one or more modulating nozzle assemblies includes a plurality of modulating nozzle assemblies.

27. A method for controlling one or more modulating nozzle assemblies of an agricultural sprayer comprising:
receiving a specified field flow rate and a specified droplet size for an agricultural product;
monitoring an agricultural sprayer speed, wherein the agricultural sprayer speed is dynamic;
determining one or more instructions for control of the one or more modulating nozzle assemblies, determining the one or more instructions includes:
generating an orifice profile instruction based on the specified field flow rate, the specified droplet size and the monitored agricultural sprayer speed;
controlling the one or more modulating nozzle assemblies, controlling includes:
actuating one or more spray tip modulating elements according to the orifice profile instruction, the one or more spray tip modulating elements associated with the one or more modulating nozzle assemblies; and
modulating one or more orifice profiles according to the actuating of the one or more spray tip modulating elements; and
spraying the agricultural product from the one or more modulating nozzle assemblies with the specified droplet size according to the modulated one or more orifice profiles.

28. The method of claim 27 comprising determining a sprayed flow rate of the agricultural product for the one or more modulating nozzle assemblies, the sprayed flow rate based on the specified field flow rate and the monitored agricultural sprayer speed.

29. The method of claim 28, wherein generating the orifice profile instruction based on the specified field flow rate, the specified droplet size and the monitored agricultural sprayer speed includes generating the orifice profile instruction based on the sprayed flow rate and the specified droplet size.

30. The method of claim 27, wherein spraying the agricultural product from the one or more modulating nozzle assemblies with the specified droplet size according to the modulated one or more orifice profiles includes spraying the agricultural product from the one or more modulating nozzle assemblies with the specified droplet size while varying the agricultural sprayer speed and the corresponding sprayed flow rate for the one or more modulating nozzle assemblies.

31. The method of claim 27, wherein determining the one or more instructions for control of the one or more modulating nozzle assemblies includes:
generating a pressure instruction based on the specified field flow rate, the specified droplet size and the monitored agricultural sprayer speed.

32. The method of claim 31 comprising controlling a system pressure according to the pressure instruction to achieve the specified droplet size.

33. The method of claim 27, wherein generating the orifice profile instruction based on the specified field flow rate, the specified droplet size and the monitored agricultural sprayer speed includes implementing one or more of a chart, algorithm or equation.

34. The method of claim 27, wherein the one or more modulating nozzle assemblies each include a nozzle base and a shuttle movably coupled with the nozzle base; and
actuating the one or more spray tip modulating elements according to the orifice profile instruction includes moving the shuttle relative to the nozzle base to set the one or more orifice profiles according to the orifice profile instruction.

35. The method of claim 27, wherein monitoring the agricultural sprayer speed includes monitoring one or more of a sprayer chassis speed or one or more nozzle assembly speeds.

36. The method of claim 35, wherein monitoring the agricultural sprayer speed includes monitoring one or more different nozzle assembly speeds.

37. The method of claim 36 comprising determining a sprayed flow rate of the agricultural product for the one or more modulating nozzle assemblies, the sprayed flow rate based on the specified field flow rate and the one or more different nozzle assembly speeds.
